(19) United States
(12) Patent Application Publication
(10) Pub. No.: US 2024/0403753 A1
(43) Pub. Date: Dec. 5, 2024

(54) AUTOMATED GENERATION AND RECOMMENDATION OF GOAL-ORIENTED TASKS

(71) Applicant: Yohana LLC, Palo Alto, CA (US)

(72) Inventors: Yoky Matsuoka, Los Altos Hills, CA (US); Nitin Viswanathan, San Francisco, CA (US); Gwendolyn W. van der Linden, Redwood City, CA (US); Amy Y. Seng, El Cerrito, CA (US); Lingyun Liu, Sunnyvale, CA (US); Benjamin Deming, Campbell, CA (US); Sean Paterson, Mountain View, CA (US)

(21) Appl. No.: 18/807,708

(22) Filed: Aug. 16, 2024

Related U.S. Application Data
(63) Continuation of application No. 17/843,008, filed on Jun. 17, 2022.
(60) Provisional application No. 63/211,965, filed on Jun. 17, 2021.

(51) Int. Cl. G06Q 10/0631; G06F 40/40

(52) U.S. Cl. CPC G06Q 10/063112; G06F 40/40; G06Q 10/063114

(57) ABSTRACT

Systems and methods for identifying and recommending tasks that may be performed in order to achieve member goals are provided. A system processes messages in real-time as these messages are exchanged to identify a goal and a timeframe from achieving the goal. Based on the goal and the corresponding timeframe, the system identifies task groupings corresponding to different methods for achieving the goal. The task groupings are ordered according to the likelihood of the member selecting a task grouping. When a member selects a task grouping, the system can monitor in real-time the performance of tasks of the task grouping to determine whether the goal is being achieved. If any tasks are not being performed successfully, the system can automatically adjust the remaining tasks, select new tasks, and/or adjust the timeframe for achieving the goal in order to provide the member with an opportunity to achieve the goal.

### CROSS-REFERENCE TO RELATED APPLICATIONS

The present patent application is a continuation of U.S. patent application Ser. No. 17/843,008 filed Jun. 17, 2022, which claims the priority benefit of U.S. Provisional Patent Application No. 63/211,965 filed Jun. 17, 2021, the disclosures of which are incorporated herein by reference in its entirety.

### FIELD

The present disclosure relates to the determination and delegation of tasks based on identified member goals. In one example, the systems and methods described herein may be used to identify and recommend tasks that may be performed in order to achieve one or more member goals. Further, the systems and methods described herein may be used to provide automated coordination for the performance of tasks associated with the one or more member goals.

### SUMMARY

Disclosed embodiments may provide a framework to identify and recommend tasks that may be performed in order to achieve member-specific goals. According to some embodiments, a computer-implemented method is provided. The computer-implemented method comprises receiving in real-time a set of messages between a member and a representative as the set of messages are being exchanged. The computer-implemented method further comprises processing the set of messages in real-time to automatically identify a goal specific to the member and a timeframe for achieving the goal. The set of messages are processed according to member attributes specified in a member profile corresponding to the member and historical data corresponding to previously identified goals for similarly-situated members. The computer-implemented method further comprises identifying a task grouping for achieving the goal. The task grouping is determined based on a set of characteristics associated with the goal. Further, the task grouping corresponds to a method for achieving the goal. The computer-implemented method further comprises generating a proposal option corresponding to the task grouping. The computer-implemented method further comprises receiving input corresponding to a selection of the proposal option. The selection indicates that the task grouping is to be performed to achieve the goal. The computer-implemented method further comprises monitoring performance of the task grouping in real-time according to the timeframe. The computer-implemented method further comprises updating the member profile. The member profile is updated using the goal, the proposal option, the selection, and the performance of the task grouping.

In some embodiments, the computer-implemented method further comprises determining that one or more tasks of the task grouping have not been completed according to the timeframe. The computer-implemented method further comprises generating a new timeframe for completion of the task grouping. The computer-implemented method further comprises monitoring the performance of the task grouping according to the new timeframe.

In some embodiments, monitoring the performance of the task grouping includes receiving data in real-time from one or more personal devices associated with the member. Monitoring the performance of the task grouping further includes processing the data from the one or more personal devices associated with the member to determine whether the data corresponds to completion of tasks associated with the task grouping.

In some embodiments, monitoring the performance of the task grouping includes receiving in real-time a new set of messages between the member and the representative as the new set of messages are being exchanged. Monitoring the performance of the task grouping further includes using a Natural Language Processing (NLP) algorithm to determine the performance of the task grouping. The NLP algorithm uses the new set of messages as input.

In some embodiments, the computer-implemented method further comprises determining that one or more tasks associated with the task grouping have not been completed according to the timeframe. The computer-implemented method further comprises identifying a new task grouping for achieving the goal according to the timeframe. The computer-implemented method further comprises generating a new proposal option to provide the new task grouping.

In some embodiments, the computer-implemented method further comprises calculating a cognitive load score for the member. The cognitive load score is calculated based on active tasks associated with the member that are being performed. The computer-implemented method further comprises determining whether the timeframe for achieving the goal is feasible based on the cognitive load score.

In some embodiments, the similarly-situated members are identified using a clustering algorithm according to one or more vectors of similarity between the member and the similarly-situated members.

In some embodiments, the task grouping is selected from an ordering of task groupings. The task groupings are ordered according to a likelihood of the member selecting a particular task grouping that is to be performed to achieve the goal.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which projects and tasks related to a goal defined by a member are generated and provided by a task facilitation service in accordance with at least one embodiment;

FIG. 2 shows an illustrative example of an environment in which a task recommendation system generates and ranks recommendations for different tasks and/or projects that can be presented to a member for achieving a member goal in accordance with at least one embodiment;

FIG. 3 shows an illustrative example of an environment in which new projects and tasks associated with a particular member goal are provided to a member by a representative associated with the task facilitation service based on a ranking of tasks in accordance with at least one embodiment;

FIG. 4 shows an illustrative example of a project including a set of corresponding tasks performable to achieve a member goal presented to a member via an interface of the task facilitation service in accordance with at least one embodiment;

FIG. 5 shows an illustrative example of a project including a set of corresponding tasks performable to achieve a member goal presented to a member via an interface of the task facilitation service in accordance with at least one embodiment;

FIG. 6 shows an illustrative example of a project including a set of corresponding tasks performable to achieve a member goal presented to a member via an interface of the task facilitation service in accordance with at least one embodiment;

FIG. 7 shows an illustrative example of an environment in which a task coordination system assigns and monitors performance of tasks associated with a particular goal by a representative and/or a member in accordance with at least one embodiment;

FIG. 8 shows an illustrative example of a process for generating one or more proposals and corresponding tasks for achieving a member goal based on communications between a member and a representative in accordance with at least one embodiment;

FIG. 9 shows an illustrative example of a process for training and using a machine learning algorithm to generate possible tasks for achieving a member goal in accordance with at least one embodiment;

FIG. 10 shows an illustrative example of a process for monitoring member performance of tasks associated with a member goal and automatically adjusting a timeframe and/or tasks associated with the member goal upon detection of deviations from an original timeframe for achieving the member goal in accordance with at least one embodiment;

FIG. 11 shows an illustrative example of an environment in which communications with members are processed in accordance with at least one embodiment; and

FIG. 12 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to identify and recommend tasks that may be performed in order to achieve member-specific goals. Through this framework, a task facilitation service can process messages in real-time as these messages are exchanged in order to identify a goal and a timeframe for achieving this goal. Based on the identified goal and corresponding timeframe, the task facilitation service can identify task groupings corresponding to different methods for achieving the identified goal. The task groupings are ordered according to the likelihood of the member selecting a task grouping. When a member selects a task grouping, the task facilitation service can monitor in real-time the performance of tasks of the task grouping to determine whether the goal is being achieved. If any tasks are not being performed successfully, the task facilitation service can automatically adjust the remaining tasks, select new tasks, and/or adjust the timeframe for achieving the goal in order to provide the member with an opportunity to achieve the goal.

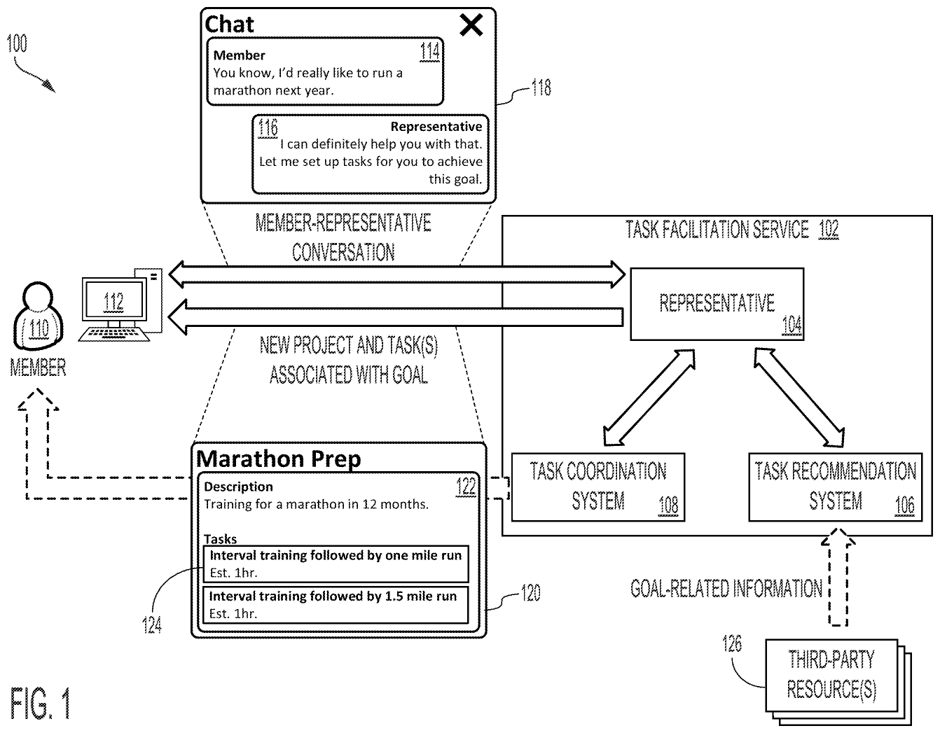

FIG. 1 shows an illustrative example of an environment 100 in which projects and tasks related to a goal defined by a member 110 are generated and provided by a task facilitation service 102 in accordance with at least one embodiment. In the environment 100, a member 110 of the task facilitation service 102 may be engaged in a communications session 118 with an assigned representative 104. The member 110, through the communications session 118, may transmit one or more messages 114 to the representative 104 to indicate that the member 110 is interested in achieving a particular goal. For example, as illustrated in FIG. 1, the member 110 may indicate that it is interested in running a marathon in the upcoming year. The representative 104, in response to these one or more messages 114 may indicate, via one or more messages 116, that it may be able to assist the member 110 in achieving the stated goal through various methods available to the representative 104 and/or implemented by the task facilitation service 102, as described herein.

The task facilitation service 102 may be implemented to reduce the cognitive load on members and their families in performing various tasks on behalf of these members and their families by identifying and delegating tasks to representatives that may coordinate performance of these tasks. A member, such as member 110, may be paired with a representative 104 during an onboarding process, through which the task facilitation service 102 may collect identifying information of the member 110. For instance, the task facilitation service 102 may provide, to the member 110, a survey or questionnaire through which the member 110 may provide identifying information usable to select a representative 104 for the member 110. The task facilitation service 102 may prompt the member 110 to provide detailed information with regard to the composition of the member's family (e.g., number of inhabitants in the member's home, the number of children in the member's home, the number and types of pets in the member's home, etc.), the physical location of the member's home, any special needs or requirements of the member 110 (e.g., physical or emotional disabilities, etc.), and the like. In some instances, the member 110 may be prompted to provide demographic information (e.g., age, ethnicity, race, languages written/spoken, etc.). The member 110 may also be prompted to indicate any personal goals that may be used to identify possible projects and tasks that may be performed in order to achieve these goals (described in greater detail herein).

In an embodiment, the data associated with the member 110 is used by the task facilitation service 102 to create a member profile corresponding to the member 110. As noted above, the task facilitation service 102 may provide, to the member 110, a survey or questionnaire through which the member 110 may provide identifying information associated with the member 110. The responses provided by the member 110 to this survey or questionnaire may be used by the task facilitation service 102 to generate an initial member profile corresponding to the member 110. In an embodiment, once a representative has been assigned to the member 110, the task facilitation service 102 can prompt the member 110 to generate a new member profile corresponding to the member 110. For instance, the task facilitation service 102 may provide the member 110 with a survey or questionnaire that includes a set of questions that may be used to supplement the information previously provided during the aforementioned onboarding process. For example, through the survey or questionnaire, the task facilitation service 102 may prompt the member 110 to provide additional information about family members, important dates (e.g., birthdays, etc.), dietary restrictions, and the like. Based on the responses provided by the member 110, the task facilitation service 102 may update the member profile corresponding to the member 110.

In some instances, the member profile may be accessible to the member 110, such as through an application or web portal provided by the task facilitation service 102. Through the application or web portal, the member 110 may add, remove, or edit any information within the member profile. The member profile, in some instances, may be divided into various sections corresponding to the member, the member's family, the member's home, and the like. Each of these sections may be supplemented based on the data associated with the member 110 collected during the onboarding process and on any responses to the survey or questionnaire provided to the member 110 after assignment of a representative to the member 110. Additionally, each section may include additional questions or prompts that the member 110 may use to provide additional information that may be used to expand the member profile. For example, through the member profile, the member 110 may be prompted to provide any credentials that may be used to access any external accounts (e.g., credit card accounts, retailer accounts, etc.) in order to facilitate completion of tasks.

The collected identifying information may be used by the task facilitation service 102 to identify and assign a representative 104 to the member 110. For instance, the task facilitation service 102 may use the identifying information of a member 110, as well as any information related to the member's level of comfort or interest in delegating tasks to others, and any other information obtained during the onboarding process as input to a classification or clustering algorithm configured to identify representatives that may be well-suited to interact and communicate with the member 110 in a productive manner. Using the classification or clustering algorithm, the task facilitation service 102 may identify a representative 104 that may be more likely to develop a positive, long-term relationship with the member 110 while addressing any tasks that may need to be addressed for the benefit of the member 110. In some instances, the task facilitation service 102 may select a representative 104 based on information corresponding to the availability of the set of representatives associated with the task facilitation service 102. For instance, the task facilitation service 102 may automatically select the first available representative from a set of representatives. In some instances, the task facilitation service 102 may automatically select the first available representative that satisfies one or more criteria corresponding to the member's identifying information. For example, the task facilitation service 102 may automatically select an available representative that is within geographic proximity of the member 110, shares a similar background as that of the member 110, and the like.

The representative 104 may be an individual that is assigned to the member 110 according to degrees or vectors of similarity between the member's and representative's demographic information. For instance, if the member 110 and the representative 104 share a similar background (e.g., attended university in the same city, are from the same hometown, share particular interests, etc.), the task facilitation service 102 may be more likely to assign the representative 104 to the member 110. Similarly, if the member 110 and the representative 104 are within geographic proximity to one another, the task facilitation service 102 may be more likely to assign the representative 104 to the member 110.

In an embodiment, the representative 104 can be an automated process, such as a bot, that may be configured to automatically engage and interact with the member 110. For instance, the task facilitation service 102 may utilize the responses provided by the member 110 during the onboarding process as input to a machine learning algorithm or artificial intelligence to generate a member profile and a bot that may serve as a representative 104 for the member 110. The bot may be configured to autonomously chat with the member 110 to generate tasks and proposals, perform tasks on behalf of the member 110 in accordance with any approved proposals, and the like as described herein. The bot may be configured according to the parameters or characteristics of the member 110 as defined in the member profile. As the bot communicates with the member 110 over time, the bot may be updated to improve the bot's interaction with the member 110.

When a representative 104 is assigned to the member 110 by the task facilitation service 102, the task facilitation service 102 may notify the member 110 and the representative 104 of the pairing. Further, the task facilitation service 102 may establish a chat session or other communications session between the member 110 and the assigned representative 104 to facilitate communications between the member 110 and the representative 104. For instance, via a web portal or an application provided by the task facilitation service 102 and installed on the computing device 112, the member 110 may exchange messages with the assigned representative 104 over the chat session or other communication session. Similarly, the representative 104 may be provided with an interface through which the representative may exchange messages with the member 110.

In an embodiment, the representative 104 can suggest one or more tasks based on member characteristics, task history, and other factors. For instance, as the member 110 communicates with the representative 104 over the communications session 118 and/or through any other communications session established for different tasks and projects, the representative 104 may evaluate any messages 114 from the member 110 to identify any tasks that may be performed to reduce the member's cognitive load. As an illustrative example, if the member 110 indicates, over the communications session 118, that their spouse's birthday is coming up, the representative 104 may utilize their knowledge of the member 110 to develop one or more tasks that may be recommended to the member 110 in anticipation of their spouse's birthday. The representative 104 may recommend tasks such as purchasing a cake, ordering flowers, setting up a unique travel experience for the member 110, and the like. In some embodiments, the representative 104 can generate task suggestions without member input. For instance, as part of the onboarding process, the member 110 may provide the task facilitation service 102 with access to one or more member resources, such as the member's calendar, the member's personal fitness devices (e.g., fitness trackers, exercise equipment having communication capabilities, etc.), the member's vehicle data, and the like. Data collected from these member resources may be monitored by the representative 104, which may parse the data to generate task suggestions for the member 110.

In an embodiment, a representative 104 can determine, based on one or more messages 114 from the member 110 over the communications session 118, whether the member 110 has defined a goal that it wishes to achieve and for which the task facilitation service 102 may be utilized to identify possible projects and corresponding tasks that may be performed to achieve this goal. For example, as illustrated in FIG. 1, the member 110 may indicate, in a message 114 transmitted to the representative 104 over the communications session 118, that the member 110 would like to achieve a goal of running a marathon in the coming year. The representative 104, receiving this message 114, may discern the member's stated goal. The representative 104, via an interface provided by the task facilitation service 102, may access a project generation template, through which the representative 104 may provide information related to the goal that the member wishes to achieve. The information may include information related to the member 110 (e.g., member name, member address, etc.) as well as various parameters of the goal itself (e.g., description of the goal that the member 110 wishes to achieve, the timeframe for achieving the goal, any member 110 constraints that are to be considered for the goal, and the like). The parameters of the task may further include any member preferences (e.g., preferred training times, preferred method(s) of instruction, etc.).

In an embodiment, the task facilitation service 102 may maintain a resource library that may serve as a repository for different project generation templates. These project generation templates may correspond to different goal types or categories. For example, the task facilitation service 102 may maintain, within the resource library, a project generation template for projects related to weight loss or other dietary-related goals. As another illustrative example, the task facilitation service 102 may maintain a project generation template for projects that may be related to personal fitness goals. As yet another illustrative example, the task facilitation service 102 may maintain a project generation template for projects that may be related to learning new skills (e.g., cooking skills, language skills, sports-related skills, mountaineering skills, survival skills, etc.). The different project generation templates may include different data fields that may be used to define a particular project for helping a member 110 accomplish a particular goal. For example, a project generation template corresponding to dietary-related goals may include data fields through which a representative 104 may define the member's current physiological data (e.g., weight, body-mass index, blood pressure, cholesterol levels, etc.), any dietary restrictions (e.g., food allergies, food aversions, etc.), and the like. As another example, a project generation template corresponding to running-related goals may include data fields through which a representative 104 may define the member's current running ability (e.g., longest distance run, run times, run frequency, etc.).

In an embodiment, the task facilitation service 102 can automatically populate one or more data fields from a selected project generation template based on information provided in the member profile associated with the member 110. For example, if the selected project generation template corresponds to dietary-related goals, the task facilitation service 102 may automatically populate any data fields within the template corresponding to the member's dietary restrictions based on information within the member profile that indicates the member's dietary restrictions. As another illustrative example, if the selected project generation template corresponds to language skills-related goals, the task facilitation service 102 may automatically process the member profile associated with the member 110 to determine any of the member's language proficiencies (e.g., particular languages known, speech fluency in these languages, writing fluency in these languages, level of conversational comfort in these languages, etc.). Based on the language indicated by the member 110 to the representative 104, the task facilitation service 102 may automatically process the member profile associated with the member 110 to determine the member's present proficiency (if indicated) for the selected language and automatically populate any relevant data fields within the project generation template for this goal.

In an embodiment, the representative 104 can provide the information obtained from the member 110 for the goal specified in the one or more messages exchanged between the member 110 and the representative 104 to a task recommendation system 106 of the task facilitation service 102 to dynamically, and in real-time, generate a project comprising one or more tasks that may be performed within a particular timeframe to enable the member 110 to reach its stated goal. The task recommendation system 106 may be implemented using a computer system or as an application or other executable code implemented on a computer system of the task facilitation service 102. The task recommendation system 106, in an embodiment, provides the representative 104 with an interface through which the representative 104 may define a goal for the member 110 that may be achieved with the assistance of the representative 104 and/or one or more third parties or other entities associated with the task facilitation service 102. For instance, the representative may provide a name for the goal, any known parameters of the goal as provided by the member 110 (e.g., budgets, constraints (temporal, physical, etc.), timeframes, etc.), and the like. As an illustrative example, if the member 110 transmits the message “You know, I'd really like to run a marathon next year,” the representative 104 may evaluate the message 114 and generate a goal for the member 110 entitled “Run a Marathon.” For this goal, the representative 104 may indicate that the timeframe for completion of the task is the end of the upcoming year, as indicated by the member 110. Further, the representative 104 may add additional information known to the representative 104 about the member 110. For example, the representative 104 may indicate any available times during the day or week for running and training, known physical fitness of the member 110, known exercise routines or schedules for the member 110, and the like. As noted above, the task facilitation service 102 may automatically obtain this additional information from the member profile associated with the member 110. For example, if the member profile indicates the available times during the day or week during which the member 110 may engage in activities that may be conducive towards achieving a particular goal, the task facilitation service 102 may automatically provide this information from the member profile for use in defining the goal.

In an embodiment, the task recommendation system 106 can automatically, and in real-time, process the messages 114, 116 exchanged between the member 110 and the representative 104 over the communications session 118 to identify any possible goals for the member 110. For instance, the task recommendation system 106 may process any messages between the member 110 and the representative 104 as these messages are being exchanged using a machine learning algorithm or artificial intelligence to automatically identify any member goals for which the representative 104 and the task facilitation service 102 may provide assistance to the member 110 for achieving these goals. For instance, the task recommendation system 106 may utilize natural language processing (NLP) or other artificial intelligence to evaluate exchanged messages or other communications from the member 110 to identify any goals that the member 110 would like to achieve with the assistance of the representative 104 and the task facilitation service 102. In some instances, the task recommendation system 106 may utilize historical data corresponding to previously identified goals for similarly-situated members and corresponding messages from these members to train the NLP or other artificial intelligence to identify possible goals. If the task recommendation system 106 identifies one or more goals that the member 110 may wish to achieve with the assistance of the representative 104 and the task facilitation service 102, the task recommendation system 106 may present these goals to the representative 104, which may communicate with the member 110 over the communications session 118 to indicate that it has identified these goals and that it will accordingly generate tasks that may be performed to assist the member 110 in achieving these goals. For instance, as illustrated via message 116 in FIG. 1, the representative 104 may indicate that it can help the member 110 with their stated goal of running a marathon in the coming year.

In an embodiment, once a new goal has been identified, the task recommendation system 106 can automatically generate a project-specific interface 120 for the identified goal. Through this project-specific interface 120, as described in greater detail below, the representative 104 and/or the task recommendation system 106 may provide the member 110 with a description of the particular goal that is to be achieved. This description may specify any applicable timeframes for completion of the goal, information corresponding to the particular goal (e.g., the particular metrics that are to be achieved, details corresponding to the distribution of responsibility between the member 110 and the representative 104 or other entities, etc.), any associated expenses associated with the goal, and the like. Further, the project-specific interface 120 may include any tasks 124 that are to be completed in order to achieve the indicated goal. In some instances, the task recommendation system 106 may facilitate, through the project-specific interface 120, a goal-specific communications session. This goal-specific communication session may be distinct from the communications session 118, whereby communications exchanged within the goal-specific communication session may be specific to the goal that is to be achieved. Further, for any tasks 124 associated with the particular, the task recommendation system 106 may facilitate task-specific communications sessions, through which the member 110 and the representative 104 may communicate according to the corresponding task associated with the goal.

In an embodiment, once a goal has been identified and generated for the member 110 (either through manual entry by the representative 104 or through the use of machine learning or artificial intelligence by the task recommendation system 106, as described above), the representative 104 can generate one or more tasks that may be performed to accomplish the new goal. The task recommendation system 106, through the aforementioned interface provided to the representative 104, may allow the representative 104 to generate one or more tasks for the newly created goal and that may be presented to the member over the project-specific interface 120 (e.g., via the web portal or application utilized by the member 110, etc.) and that may be completed by the representative 104, third-party services or other entities associated with the task facilitation service 102, and/or the member 110 in order to achieve the new goal. For instance, the representative 104 may provide a name for the task, any known parameters of the task (e.g., timeframes, task operations to be performed, etc.), and the like. As an illustrative example, for the member's goal to run a marathon in the coming year, the representative 104 may generate a task entitled “Interval training followed by one mile run.” For this task, the representative 104 may indicate that the timeframe for completion of the task is one hour, as this is the amount of time that may be required for the member 110 to complete the task. Further, the representative may indicate a completion date for the task in accordance with the overall timeframe for achieving the goal. For example, if the timeframe for achieving the goal is twelve months, the representative 104 may indicate a specific date for completion of the task in order for the member 110 to be on track for achieving the goal within the stated twelve-month timeframe.

In an embodiment, the task recommendation system 106 can automatically generate a set of tasks 124 that can be completed by the member 110, the representative 104, and/or any third-party entity or other entity associated with the task facilitation service 102 for the new goal. For instance, the task recommendation system 106 may use the new goal, information corresponding to the member 110 (such as from the member profile), and historical data corresponding to goals and corresponding tasks performed by similarly-situated members as input to a machine learning algorithm or artificial intelligence to identify any tasks 124 that may be performed to achieve the member's new goal. For example, if the new goal is related to running a marathon within a particular timeframe, the task recommendation system 106 may utilize the machine learning algorithm or artificial intelligence to identify similarly-situated members (e.g., other members that have previously trained for a marathon within similar timeframes, other members having a fitness level similar to that of the member 110, other members with similar daily time constraints for training, etc.). Based on the characteristics of the new goal (e.g., category of the goal, timeframe for achieving the goal, etc.), characteristics of the member 110, and data corresponding to these similarly-situated members, the task recommendation system 106 may automatically generate a set of tasks 124 that may be performed within the stated timeframe to achieve the new goal. As an illustrative example, for the aforementioned goal of running a marathon within the next twelve months, the task recommendation system 106 may automatically generate a set of tasks 124 that may be performed by the member 110 to train for a marathon over the next twelve months. Each task of the set of tasks may serve to incrementally improve the member's performance in anticipation of achieving the goal.

The machine learning algorithm or artificial intelligence utilized by the task recommendation system 106 to automatically, and dynamically, generate a set of tasks 124 for accomplishing an identified goal may be trained using supervised training techniques. For instance, a dataset of member profiles, corresponding goals, tasks generated for these goals, and performance metrics corresponding to the performance of these tasks to achieve these goals (e.g., likelihood of success in achieving goal as a result of performance of corresponding tasks, feedback related to the tasks presented and performed for each goal, any deviations from the provided tasks or timeframes for the goals, etc.) can be selected for training of the machine learning algorithm or artificial intelligence. The machine learning algorithm or artificial intelligence can be evaluated to determine, based on the sample inputs supplied to the machine learning algorithm or artificial intelligence, whether the machine learning algorithm or artificial intelligence is producing a set of tasks that are conducive to achieving a corresponding goal within a predefined timeframe. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from members and representatives with regard to the tasks provided by the machine learning algorithm or artificial intelligence for given goals. For instance, the task recommendation system 106 may obtain new feedback from the member after performance of a set of tasks generated by the task recommendation system 106 corresponding to a particular goal. The machine learning algorithm or artificial intelligence may use this feedback to determine whether the set of tasks were conducive to the member 110 achieving their goal. This determination may be used to further train the machine learning algorithm or artificial intelligence to provide better tasks that may be performed to achieve similar goals.

In an embodiment, the task recommendation system 106 can automatically query one or more third-party resources 126 to identify possible tasks that may be performed in order to achieve a new goal. For instance, the task facilitation service 102 may partner with various organizations that provide or otherwise aggregate information related to different hobbies or interests that may be associated with different goal categories (e.g., exercise activities, learning trades, etc.). As an illustrative example, the task facilitation service 102 may partner with a publisher of an exercise magazine to obtain any recent news or information related to advances in training and to any upcoming events that may serve as the final task for achieving an exercise-related goal. For instance, from this publisher, the task recommendation system 106 may automatically identify a training plan for running a marathon within twelve months and a marathon within the member's 110 geographic location at the end of twelve months that the member 110 may wish to run and serve as an indication as to whether the member 110 has achieved its goal. As another illustrative example, the task facilitation service 102 may partner with different online trade schools or instructional organizations to identify any classes or learning plans that may be used to define tasks for achieving goals related to learning a new trade or skill. For instance, if the new goal corresponds to the member's desire to learn how to cook Puerto Rican food within a particular timeframe in order to prepare such food for an event, the task recommendation system 106 may query these third-party resources 126 to identify any classes or lesson plans that may be provided to the member 110 in the form of individual tasks. For example, if a cooking school near the member 110 is offering classes related to Puerto Rican cooking, the task recommendation system 106 may generate a task for each class and coordinate with the representative 104 to present the member 110 with an option to enroll in these classes in order to achieve the member's goal.

In an embodiment, the third-party resources 126 are also available to the representative 104, whereby the representative 104 can utilize these third-party resources 126 to obtain information related to a particular goal and manually generate a set of tasks 124 for achieving the particular goal. For instance, as illustrated in FIG. 1, if the member 110 has indicated that it would like to run a marathon in the coming year, the representative 104 can access a publisher of an exercise magazine to obtain any recent news or information related to advances in training and to any upcoming events that may serve as the final task for achieving the member's goal. The representative 104, based on this information from the publisher of the exercise magazine, may manually generate a set of tasks 124 corresponding to any training plans or other information provided by the publisher. Further, the representative 104 can evaluate this exercise magazine and information from local running clubs within the member's geographic area for any marathons that are scheduled in the coming year and after the timeframe defined by the member 110 for training.

In an embodiment, the third-party resources 126 may be made available through a resource library maintained by the task facilitation service 102. In addition to serving as a repository for different project generation templates that may be used for a particular goal, the resource library may also serve as a repository for various resources that may be used to generate new projects and/or tasks that may be performed for the benefit of members of the task facilitation service 102. For instance, the resource library may store information related to one or more third-party resources 126 that may be used to define possible projects and/or tasks. Additionally, the resource library may store information corresponding to different tasks that may have been previously performed for different goals or goal types/categories.

In some instances, representatives and third-party entities may update the resource library based on their knowledge of tasks that may be performed in order to achieve a new goal. For example, if a representative 104 identifies a particular culinary school through which a member 110 may attend one or more courses in order to achieve a goal of learning how to cook Puerto Rican food, the representative 104 may create, within the resource library, an entry corresponding to the culinary school. Further, the representative 104 may associate this entry with particular goal types or categories corresponding to culinary training. Thus, if another representative submits a query to the resource library to identify any third-party resources 126 that may be used to identify possible tasks for a culinary training-related goal, the resource library may return the entry corresponding to the culinary school. Additionally, if the representative 104 defines any tasks based on information garnered from the culinary school, these tasks may be associated with the entry corresponding to the culinary school. This may allow other representatives to also identify these previously performed tasks upon review of the entry for the culinary school provided in response to their query.

In an embodiment, if the task recommendation system 106 identifies a goal expressed by the member 110 or otherwise submitted by the representative 104 on behalf of the member 110, the task recommendation system 106 can utilize the resource library maintained by the task facilitation service 102 to automatically identify one or more tasks associated with the goal that may be recommended to the representative 104. For example, if the task recommendation system 106 identifies a goal related to the member's indication that they wish to run a marathon in the upcoming year, the task recommendation system 106 may query the resource library to identify any tasks associated with the stated goal of running a marathon in the upcoming year. In some instances, the query to the resource library may include member attributes garnered from the member profile associated with the member 110. This may allow the task recommendation system 106 to identify any tasks that may have been performed or otherwise proposed to similarly-situated members (e.g., members in similar geographic locations, members having similar attributes to that of the present member, etc.) for similar goals. In some instances, the task recommendation system 106 may automatically utilize the resource library to identify any third-party resources 126 that may be used to identify possible tasks that may be performed to achieve the particular goal. For instance, from the resource library, the task recommendation system 106 may automatically identify any third-party resources 126 previously utilized to generate tasks for similarly-situated members and/or for similar goals.

In an embodiment, the task recommendation system 106 can automatically determine whether the member's stated goal is achievable within the timeframe provided by the member 110. For instance, using the aforementioned machine learning algorithm or artificial intelligence, the task recommendation system 106 may automatically, and dynamically, obtain a set of tasks 124 for accomplishing the identified goal. The obtained set of tasks 124 may correspond to a particular timeframe as determined by the machine learning algorithm or artificial intelligence. If this timeframe extends beyond the timeframe defined by the member 110 in its communications with the representative 104, the task recommendation system 106 may determine that the goal cannot be achieved within the member's specified timeframe. As another example, the task recommendation system 106 and/or the representative 104 may determine, based on a review of one or more third-party resources 126, whether the stated goal can be achieved within the timeframe specified by the member 110. For instance, if the task recommendation system 106 determines, based on information obtained from one or more third-party resources 126, that achievement of the stated goal would require a timeframe that extends beyond the timeframe defined by the member 110 in its communications with the representative 104, the task recommendation system 106 may determine that the goal cannot be achieved within the member's specified timeframe.

If the task recommendation system 106 determines that the stated goal cannot be achieved within the timeframe provided by the member 110, the task recommendation system 106 may transmit a recommendation to the representative 104 indicating an alternative timeframe for achieving the goal. As noted above, using the aforementioned machine learning algorithm or artificial intelligence, the task recommendation system 106 may automatically, and dynamically, obtain a set of tasks 124 and a particular timeframe for achieving the stated goal. The task recommendation system 106 may provide this timeframe to the representative 104, which may communicate this timeframe to the member 110 over the communications session 118. The member 110 may review the alternative timeframe for achieving its stated goal and determine whether to proceed with the goal. If the member 110 determines that it no longer wants to pursue the stated goal, the representative 104 may remove the goal and any identified tasks from the member's profile. However, if the member 110 determines that it wishes to continue pursuing the goal subject to the recommended timeframe for achieving the goal, the representative 104 may update the template for the goal to indicate this recommended timeframe for achieving the goal. Alternatively, the task recommendation system 106 may automatically, and in real-time, detect the response from the member 110 (such as through use of NLP or other machine learning algorithm/artificial intelligence) and, based on the response, update the template for the goal to indicate the recommended timeframe (if accepted) or to remove the template (if the timeframe is rejected).

In an embodiment, a listing of the set of tasks that may be recommended to the member 110 may be provided to the representative 104 for a final determination as to which tasks may be presented to the member 110 for achieving the stated goal. In some instances, the task recommendation system 106 may group different tasks according to different methods for achieving the stated goal within the given timeframe. For instance, if the stated goal for a member 110 is to run a marathon in the upcoming year, the task recommendation system 106 may identify (such as through use of the machine learning algorithm/artificial intelligence and/or information from third-party resources 126) sets of tasks for different training plans that may be implemented to train the member 110 for running a marathon in the upcoming year. In an embodiment, the task recommendation system 106 can rank the different groups of tasks based on a likelihood of the member 110 selecting a particular group of tasks for accomplishing the stated goal.

The representative 104 may review the groupings of tasks recommended by the task recommendation system 106 and select one or more of these groupings for presentation to the member 110 through a proposal. For instance, the representative 104 can generate a proposal for achieving the stated goal. A proposal may provide, amongst other things, a list of options for different ways that the goal may be achieved. Each option may include a grouping of tasks that may be performed to achieve the stated goal within a given timeframe. The various options in a proposal may be presented to the member 110 over the communications session facilitated by the task facilitation service 102 for the particular goal (e.g., through the project-specific interface 120) and via the web portal or application provided by the task facilitation service 102. A proposal may further identify any third-party resources 126 (if any) that are to be engaged for completion of one or more tasks corresponding to the goal, a budget estimate for completion of the goal, resources or types of resources to be used for completion of the goal, and the like. Based on the member responses to the various options presented in the proposal, the representative 104 may present tasks 124 associated with a selected option via the project-specific interface 120, through which the member 110 may review a project 122 corresponding to the stated goal and the tasks 124 corresponding to the selected proposal option for the particular project 122.

In an embodiment, to generate the proposal, the representative 104 may utilize a task coordination system 108 of the task facilitation service 102. The task coordination system 108 may be implemented using a computer system or as an application or other executable code implemented on a computer system of the task facilitation service 102. The representative 104 may present the proposal to the member 110 via the project-specific interface 120 to solicit a response from the member 110 to either proceed with the proposal or to provide an alternative proposal for completion of the tasks associated with the stated goal.

In an embodiment, the task coordination system 108 can monitor communications between the member 110 and the representative 104 for the particular goal (such as through a goal-specific communications session facilitated by the task facilitation service 102) to collect data with regard to member selection of proposal options for achieving the stated goal. For instance, the task recommendation system 108 may, dynamically and in real-time, process messages corresponding to the proposal options presented to the member 110 by the representative 104 via an interface 120 to determine a polarity or sentiment corresponding to each proposal option. For instance, if a member 110 indicates, in a message to the representative 104, that a particular proposal option includes tasks that the member is not able to perform due to time constraints or difficulty, the task coordination system 108 may ascribe a negative polarity or sentiment to this proposal option. Alternatively, if a member 110 indicates that a particular proposal option is favorable to the member 110 and that the corresponding tasks are feasible, the task coordination system 108 may ascribe a positive polarity or sentiment to this proposal option. In an embodiment, the task coordination system 108 can use these responses to the proposal options recommended to the member 110 to further train or reinforce the machine learning algorithm or artificial intelligence utilized to generate tasks and proposal options that can be presented to the member 110 and other similarly-situated members of the task facilitation service 102 for achieving similar goals.

In an embodiment, if the member 110 selects a particular proposal option that includes a set of tasks performable by the member 110, representative 104, and/or one or more third-party services or other services/entities associated with the task facilitation service 102 to achieve the stated goal, the task coordination system 108 can update the project-specific interface 120 to provide the project 122 for the stated goal that includes one or more tasks 124 that are to be performed to achieve the stated goal. The number of tasks 124 presented via the interface 120 may be determined based on known characteristics of the member 110 as may be indicated in the member profile associated with the member 110 (e.g., member preferences for level of detail required for different projects or tasks, a predefined number of tasks that are to be displayed to the member 110, etc.). For example, if a project 122 corresponding to marathon training over the coming year includes three tasks per week over the coming year, the task coordination system 108 may determine, based on the known characteristics of the member 110 (such as from the member profile), how many of these tasks 124 may be displayed via the interface 120 at any given time. This tailoring of the presentation of tasks 124 may serve to reduce the member's cognitive load, as the number of tasks 124 presented may be selected as to not overwhelm the member 110 with myriad tasks that have yet to be performed.

In an embodiment, the task coordination system 108 monitors performance of the member 110, representative 104, and/or third-party services or other services/entities associated with the task facilitation service 102 for completion of the tasks 124 associated with the project 122 for the stated goal. In some instances, a task 124 that is to be performed to achieve a stated goal may be subject to a deadline or other temporal limit. For instance, in order for the stated goal to be achieved within the predefined timeframe, each task 124 associated with the stated goal may need to be performed according to their respective deadlines or other temporal limits in order to ensure that the requisite progress is being made towards achieving the stated goal. Accordingly, the task coordination system 108 may, in real-time, process messages as they are exchanged between the member 110 and the representative 104 over the communications session associated with the current task 124 to determine whether the current task 124 for the project 122 has been performed or is in the process of being performed. If the task 124 is being performed by a third-party service or other service/entity associated with the task facilitation service 102, the task coordination system 108 may record any information provided by the third-party service or other service/entity associated with the task facilitation service 102 with regard to the performance of the task.

If the current task for the project 122 has been completed, the task coordination system 108 may indicate, via the interface 120, that the task has been completed and update the project 122 to present the next task that is to be performed for achieving the stated goal as the current task that is to be performed by the member 110, representative 104, and/or one or more third-party services. In some instances, the task coordination system 108 may update the interface 120 to provide a graphical indication that the task has been completed. For example, the task coordination system 108 may move the completed task to a section of the interface 120 corresponding to completed tasks (e.g., a “Completed To-Dos” section of the interface 120, etc.). This process may continue until the tasks 124 associated with the project 122 are completed and the stated goal is presumed achieved.

In an embodiment, the task coordination system 108 can determine whether an adjustment to the timeframe for completion of a project 122 related to a stated goal is to be performed in response to detecting that one or more tasks 124 have not been completed within their respective deadlines or other temporal limits. As noted above, the task coordination system 108 may monitor the performance of tasks 124 associated with a project 122 corresponding to a stated goal in real-time. This may include processing messages between the member 110 and the representative 104 as these messages are exchanged over the communications sessions associated with each of these tasks 124. The task coordination system 108 may utilize a machine learning algorithm or artificial intelligence (e.g., NLP) to process these messages in real-time and determine the status of a particular task 124. For example, if the member 110 indicates, in a message to the representative 104 through a communications session corresponding to a current task 124, that they are unable to perform a current task 124 within the time allotted for the task 124, the task coordination system 108 may determine that the task 124 will not be completed within the time allotted for the task 124. As another example, the task coordination system 108 may determine that no action or information corresponding to performance of the task 124 has been received at the end of the time allotted for the task 124. This may cause the task coordination system 108 to prompt the representative 104 to communicate with the member 110 and/or any third-party services or other service/entity associated with the task facilitation service 102 engaged for performance of the task 124 to determine whether the task 124 has been completed. If the representative 104 indicates that the task 124 has not been completed, the task coordination system 108 may record the task 124 as not having been completed within the allotted time for the task 124.

In an embodiment, the task coordination system 108 can collect data from the member's personal fitness devices and other sources to determine whether the current task 124 has been completed. The member 110 may provide the task facilitation service 102 with access to these one or more member resources, whereby the task coordination system 108 may periodically or at particular times access these member resources to obtain task-related data that may be used to determine whether tasks are being completed according to the allotted times for completion of these tasks. Additionally, data collected from these member resources may be monitored by the representative 104, which may parse the data to determine whether the member 110 has completed a task 124 and to determine the member's progress in achieving a stated goal, as defined by the project 122. As an illustrative example, if a particular task 124 involves having the member perform interval training followed by a one-mile run by a given time, the task coordination system 108 can obtain data from one or more fitness devices associated with the member profile. The data may include Global Positioning System (GPS) data, steps data, heart rate readings, blood pressure readings, PaO2 readings, and the like. Using this data, the task coordination system 108 may automatically determine if the member 110 has completed the particular task 124. The task coordination system 108, in some instances, may also prompt the representative 104 to communicate with the member 110 with regard to these readings to determine whether the task 124 has been completed. For example, if the GPS data for the member 110 indicates that the member 110 may have run a mile during the allotted time for the task 124, the representative 104 may transmit a message to the member 110 over the communications session corresponding to the particular task 124 to ask the member 110 whether the particular task 124 has been completed.

In an embodiment, if the task coordination system 108 determines that the current task 124 has not been completed within the allotted time for the task 124, the task coordination system 108 determines whether the stated goal can still be achieved within the original timeframe defined for the goal. For instance, the task coordination system 108 may automatically review the remaining set of tasks for the project 122 corresponding to the stated goal to determine whether these tasks 124 may be shifted to provide more time for completion of the current task without impacting the overall timeframe for achieving the goal. If the task coordination system 108 determines that the remaining set of tasks may be shifted to provide more time for completion of the current task, the task coordination system 108 may automatically, and dynamically, update the current task 124 to provide a new allotted time for completion of the task 124. This may provide the member 110, representative 104, and/or third-party services or other service/entity associated with the task facilitation service 102 performing the task 124 more time to complete the task 124. Any other tasks associated with the project 122 may also be shifted accordingly, if needed.

In some instances, if the current task 124 has not been completed within the allotted time for the task 124, the task coordination system 108 may transmit a request to the task recommendation system 106 to perform an evaluation as to whether the remaining tasks that are to be performed to achieve the stated goal may be adjusted to compensate for the inability to complete the current task 124. For instance, in response to this request, the task recommendation system 106 may automatically query the resource library and/or one or more third-party resources 126 to identify new tasks or modifications that may be made to the remaining set of tasks that may be performed to achieve the stated goal within the remaining timeframe for the stated goal. For example, if the member 110 is unable to perform a task that requires the member 110 to perform interval training followed by a one-mile run within an allotted time period, the task recommendation system 106 may determine whether one or more subsequent tasks may be adjusted to accommodate the missed interval training and one-mile run. As another example, if the task recommendation system 106 identifies a new marathon training plan from the resource library or the one or more third-party resources 126 that, if implemented, may allow the member 110 to complete its training for a marathon within the timeframe defined for the stated goal, the task recommendation system 106 can modify or replace the remaining set of tasks for the stated goal to accommodate the newly identified training plan. In some instances, if the task recommendation system 106 identifies a new set of tasks for the stated goal, the task recommendation system 106 may present this new set of tasks to the representative 104. The representative 104 may, in turn, generate a new proposal that incorporates this new set of tasks as a proposal option for the stated goal. The representative 104 may present this new proposal to the member 110 to allow the member 110 to determine whether to proceed with the new set of tasks.

In an embodiment, in addition to providing a proposal option corresponding to a new or modified set of tasks that may be completed in order to achieve the stated goal within the originally defined timeframe, the task recommendation system 106 can provide one or more additional proposal options corresponding to alternative timeframes for achieving the stated goal. For instance, the task recommendation system 106 may generate a new proposal option that includes the current task 124 and the remaining set of tasks, as originally determined by the task recommendation system 106, with a new timeframe for completion of the current task 124 and the remaining set of tasks. For instance, this new proposal option may specify a new timeframe that is shifted from the original timeframe for the stated goal by an amount of time equal to the allotted time originally provided for the current task 124. This may allow the member 110, representative 104, and/or any third-party services an opportunity to perform the current task 124 and all other subsequent tasks for the stated goal within the new timeframe.

In an embodiment, the task recommendation system 106 can use a machine learning algorithm or artificial intelligence to automatically, and dynamically, generate the new set of tasks for accomplishing the stated goal. As input to the machine learning algorithm or artificial intelligence, the task recommendation system 106 may provide, in addition to the characteristics of the goal, characteristics of the member 110 (e.g., the member profile, information extracted from the member profile, etc.), and data corresponding to similarly-situated members, data or metrics corresponding to the performance of previous tasks and the current task associated with the stated goal. The data or metrics corresponding to the performance of previous tasks and the current task may serve as an indication regarding the ability of the member 110, representative 104, and/or any third party services or other service/entity associated with the task facilitation service 102 to perform tasks associated with the stated goal. For instance, if the member 110 has been unable to keep up with the myriad tasks for a stated goal (e.g., the member 110 has lagged behind in completing tasks within the allotted times), the task recommendation system 106, using the machine learning algorithm or artificial intelligence, may determine that more time may need to be allotted to the tasks that are to be performed by the member 110 for achieving the stated goal. This, in turn, may result in a new timeframe for achieving the stated goal. In some instances, based on the member's ability to complete tasks within the allotted times, the task recommendation system 106 may also refer to the third-party resources 126 and/or the resource library maintained by the task facilitation service 102 to identify a new set of tasks that may be performed by the member 110 according to the member's identified ability to complete tasks associated with the stated goal.

The machine learning algorithm or artificial intelligence used to automatically, and dynamically, generate the new set of tasks for accomplishing the stated goal may be trained using sample datasets corresponding to the member 110 and any similarly-situated members (e.g., historical member data, historical goal and task data, performance metrics corresponding to achievement of goals based on pre- and post-adjustment of tasks, etc.) to identify one or more remedial actions that may be performed to allow the member 110 to achieve the stated goal (e.g., definition of a new timeframe for achieving the stated goal, definition of one or more new and/or alternative tasks for achieving the stated goal, etc.). As these remedial actions are performed, the historical member data and the historical goal and task data may be updated in real-time according to the success (or lack thereof) of these remedial actions in enabling members to achieve their goals. Since various tasks associated with different member goals may be performed by different members and/or on behalf of different members concurrently over time, the data used to train the machine learning algorithm or artificial intelligence may be updated dynamically in real-time as tasks are performed to achieve corresponding goals. Further, any remedial actions performed for a goal associated with a member of the task facilitation service 102 may be propagated to other members through updates made the data used to train the machine learning algorithm or artificial intelligence.

The task recommendation system 106 may provide these alternative sets of tasks and corresponding timeframes to the representative 104, which may use these alternative sets of tasks and corresponding timeframes to generate possible proposal options that may be presented to the member 110. In an embodiment, if the member 110 selects a particular proposal option that includes a set of tasks performable by the member 110, representative 104, and/or one or more third-party services or other service/entity associated with the task facilitation service 102 to achieve the stated goal, the task coordination system 108 can update the interface 120 to replace the original set of tasks currently pending for the stated goal with the alternative set of tasks corresponding to the proposal option selected by the member 110. Further, via the interface 120, the task coordination system 108 may provide the member 110 with the new timeframe for achieving the stated goal.

The task coordination system 108 may continue to monitor performance of the tasks 124 associated with the stated goal to determine whether the stated goal has been achieved. For instance, as the member 110, representative 104, and/or any third-party services or other service/entity associated with the task facilitation service 102 complete the tasks associated with the stated goal, the task coordination system 108 may automatically, and in real-time, record the progress towards achieving the stated goal. Additionally, the task coordination system 108 may monitor and process messages between the member 110 and the representative 104 in real-time and as these messages are exchanged to determine the progress towards achieving the stated goal. These messages may serve as feedback with regard to each performed task and to the overall structure of the set of tasks for achieving the stated goal. Further, once the set of tasks corresponding to the stated goal have been completed, the task coordination system 108 may transmit a request to the representative 104 to prompt the member 110 for feedback with regard to the set of tasks and as to whether the stated goal was achieved as a result of performance of the set of tasks. If the member 110 indicates that the set of tasks helped the member 110 to achieve the stated goal, the task coordination system 108 may assign a positive polarity to the set of tasks and the timeframe utilized for achieving the stated goal. Alternatively, if the member 110 indicates that the set of tasks were unfavorable and/or that performance of the set of tasks did not result in the member 110 achieving the stated goal, the task coordination system 108 may assign a negative polarity to the set of tasks and timeframe utilized for achieving the stated goal. The obtained feedback, in an embodiment, can be used to update or retrain the machine learning algorithm or artificial intelligence utilized by the task recommendation system 106 to generate different groups of tasks that may be performed to achieve similar goals for similarly-situated members.

It should be noted that for the processes described herein, various operations performed by the representative 104 may be additionally, or alternatively, performed using one or more machine learning algorithms or artificial intelligence. For example, as the representative 104 performs or otherwise coordinates performance of tasks corresponding to a stated goal over time, the task facilitation service 102 may continuously and automatically update the member profile associated with the member 110 according to member feedback related to the performance of these tasks. In an embodiment, the task recommendation system 106, after a member profile has been updated over a period of time (e.g., six months, a year, etc.) or over a set of goals and tasks (e.g., twenty tasks, thirty tasks, etc.), may utilize a machine learning algorithm or artificial intelligence to automatically and dynamically generate new tasks for stated goals based on the various attributes of the member profile (e.g., historical data corresponding to member-representative communications, member feedback corresponding to representative performance and presented proposals for achieving goals, corresponding tasks, etc.) with or without representative interaction. The task recommendation system 106 may automatically communicate with the member 110 to obtain any additional information required for new tasks associated with new goals and automatically generate proposals that may be presented to the member 110 for performance of these new tasks. The representative 104 may monitor communications between the task recommendation system 106 and the member 110 to ensure that the conversation maintains a positive polarity (e.g., the member 110 is satisfied with its interaction with the task recommendation system 106 or other bot, etc.). If the representative 104 determines that the conversation has a negative polarity (e.g., the member 110 is expressing frustration, the task recommendation system 106 or bot is unable to process the member's responses or asks, etc.), the representative 104 may intervene in the conversation. This may allow the representative 104 to address any member concerns and perform any tasks on behalf of the member 110.

Thus, unlike automated customer service systems and environments, wherein these systems and environment may have little to no knowledge of the users interacting with agents or other automated systems, the task recommendation system 106 can continuously update the member profile to provide up-to-date historical information about the member 110 based on the member's automatic interaction with the system or interaction with the representative 104 and on the proposals and corresponding proposal options provided to the member 110 and tasks performed for achieving member goals over time. This historical information, which may be automatically and dynamically updated as the member 110 or the system interacts with the representative 104 and as tasks are devised, proposed, and performed for the member 110 over time, may be used by the task recommendation system 106 to anticipate, identify, and present appropriate or intelligent responses to member 110 queries, needs, and/or goals.

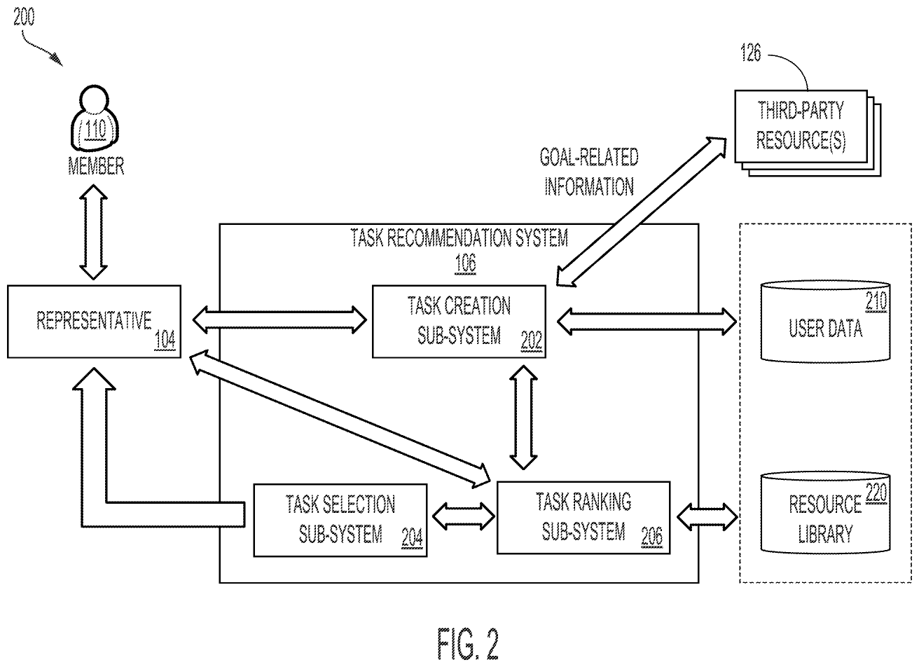

FIG. 2 shows an illustrative example of an environment 200 in which a task recommendation system 106 generates and ranks recommendations for different tasks and/or projects that can be presented to a member 110 for achieving a member goal in accordance with at least one embodiment. In the environment 200, a representative 104 interacts with a task creation sub-system 202 of the task recommendation system 106 to generate a new project corresponding a goal that the member 110 wishes to achieve within a given timeframe. The task creation sub-system 202 may be implemented using a computer system or as an application or other executable code implemented on a computer system of the task recommendation system 106.

In an embodiment, a representative 104 assigned to a member 110, or the member 110 itself, can access the task creation sub-system 202 to request creation of a new project and one or more corresponding tasks that can be performed to achieve a goal indicated by the member 110 over a communications session. For instance, as noted above, a member 110 may explicitly indicate to the representative 104 that it would like to achieve a particular goal within a timeframe. As an illustrative example, the member 110 may indicate, in a message to the representative 104 over the communications session, that it would like to run a marathon in the coming year (e.g., next twelve months). The representative 104 may evaluate this message and determine that the member 110 has defined a goal of running a marathon in the coming year. Alternatively, the member 110 may directly access the task creation sub-system 202 to request creation of a project corresponding to a particular goal that the member 110 would like to achieve. For instance, the task facilitation service may provide, via an application or web portal of the task facilitation service, a widget or other user interface element through which a member 110 may submit a request to create a project corresponding to the member's goal. In response to this request, the task creation sub-system 202 may transmit a notification to the representative 104 indicating the member's request to create a project for the stated goal. The task creation sub-system 202 may provide the representative 104 with a description of the goal, as provided by the member 110.

In an embodiment, the task creation sub-system 202, through the resource library 220, provides various templates that may be used by the representative 104 and/or the member 110 to generate a new project for a stated goal. The task creation sub-system 202 may maintain, in the resource library 220, project templates for different goal types or categories. Each project template may include different data fields for defining the project, whereby the different data fields may correspond to the goal type or category for the project being defined. The representative 104 and/or the member 110 may provide goal information via these different data fields to define the project that may be submitted to the task creation sub-system 202 for processing. In some instances, the task creation sub-system 202 can automatically populate one or more data fields from a selected project generation template based on information provided in the member profile associated with the member 110, as noted above.

In an embodiment, the task creation sub-system 202 can monitor, automatically and in real-time, messages as they are exchanged between the member 110 and the representative 104 over a communications session to identify a goal that the member 110 may want to achieve with the assistance of the representative 104 and the task facilitation service. For instance, the task creation sub-system 202 may process messages between the member 110 and the representative 104 as these messages are being exchanged using a machine learning algorithm or artificial intelligence to automatically identify any member goals for which the representative 104 and the task facilitation service may provide assistance to the member 110 for achieving these goals. The task creation sub-system 202 may utilize NLP or other artificial intelligence to evaluate these exchanged messages or other communications from the member 110 to identify any goals that the member 110 would like to achieve. In some instances, the task creation sub-system 202 may utilize historical data corresponding to previously identified goals for similarly-situated members and corresponding messages from these similarly-situated members from a user datastore 210 to train the NLP or other artificial intelligence to identify possible goals. If the task creation sub-system 202 identifies one or more goals that the member 110 wishes to achieve with the assistance of the representative 104 and the task facilitation service, the task creation sub-system 202 may present these goals to the representative 104, which may communicate with the member 110 over the communications session to indicate that it has identified these goals and that it will accordingly generate tasks that may be performed to assist the member 110 in achieving these goals.

In some instances, if the task creation sub-system 202 identifies one or more goals that the member 110 wishes to achieve, the task creation sub-system 202 may dynamically generate an interface (such as a graphical user interface (GUI)) for each identified goal. Through this interface, the task creation sub-system 202 may facilitate a new communications session between the member 110 and the representative 104, through which the member 110 and the representative 104 may exchange messages related to the particular goal. Further, as described in greater detail herein, an interface corresponding to a particular goal may be updated to provide information (such as a description) associated with the particular goal, as well as one or more tasks that may be performed to achieve the corresponding goal.

In an embodiment, the task creation sub-system 202 can process the member profile associated with the member 110 from the user datastore 210 to determine the member's cognitive load. For instance, the task creation sub-system 202 may use member profile from the user datastore 210, corresponding tasks, and member-representative conversations as input to the machine learning algorithm or artificial intelligence to generate a cognitive load score for the member 110. The task creation sub-system 202 can use the cognitive load score for the member 110 to determine whether the timeframe for achieving the goal as provided by the member 110 is feasible. For instance, the task creation sub-system 202 may determine, based on the cognitive load score for the member 110, that the timeframe for achieving the goal (as specified by the member 110) may lead to an increase in the cognitive load of the member 110 (e.g., high levels of stress may result from trying to achieve the goal and other pertinent tasks within the timeframe). If this cognitive load score exceeds a maximum cognitive load threshold value, the task creation sub-system 202 may determine that the timeframe for achieving the goal may be too onerous on the member 110 and the task creation sub-system 202 should identify an alternative timeframe that may be proposed to the member 110 and that may reduce the member's cognitive load. If the task creation sub-system 202 determines that an alternative timeframe for achievement of the goal should be proposed to the member 110, the task creation sub-system 202 may transmit a notification to the representative 104 to provide any information related to the alternative timeframe for achieving the goal. The representative 104 may propose this alternative timeframe to the member 110 via the communications session associated with the particular goal. If the member 110 opts to accept the proposed alternative timeframe, the representative 104 may indicate, to the task creation sub-system 202, that the member 110 has accepted the alternative timeframe for achieving the goal. Alternatively, if the member 110 opts to reject the proposed alternative timeframe, the representative 104 may work with the member 110 to determine whether to abandon the stated goal and/or identify alternative goals that may be achievable within the original timeframe proposed by the member 110.

Once the representative 104 has defined a new project corresponding to the member's stated goal, the task creation sub-system 202 may proceed to generate a set of tasks that may be used to generate a set of proposal options for achieving the stated goal. For instance, the task creation sub-system 202 may use information corresponding to the new goal (as defined in the new project), information corresponding to the member 110 (such as from the member profile associated with the member 110), and historical data corresponding to goals and corresponding tasks performed by similarly-situated members as input to a machine learning algorithm or artificial intelligence to identify tasks that may be performed to achieve the member's new goal. Based on characteristics of the new goal (e.g., type or category of the goal, timeframe for achieving the goal, etc.), characteristics of the member 110, and data corresponding to these similarly-situated members, the task creation sub-system 202 may automatically generate a set of tasks that may be performed within the stated timeframe to achieve the new goal, as defined in the newly created project. The machine learning algorithm or artificial intelligence utilized by the task creation sub-system 202 to automatically, and dynamically, generate a set of tasks for accomplishing an identified goal may be trained using supervised training techniques, as described above. Further, the machine learning algorithm or artificial intelligence can be evaluated to determine, based on the sample inputs supplied to the machine learning algorithm or artificial intelligence, whether the machine learning algorithm or artificial intelligence is producing a set of tasks that are conducive to achieving a corresponding goal within a predefined timeframe. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from members and representatives with regard to the tasks provided by the machine learning algorithm or artificial intelligence for given goals.

In an embodiment, to automatically generate one or more tasks that may be performed to allow the member 110 to achieve their stated goal, the task creation sub-system 202 can query one or more third-party resources 126 to identify possible tasks that may be added to the new project for achieving the stated goal. For instance, the task creation sub-system 202 may automatically utilize the resource library 220 to identify any third-party resources 126 that may be used to identify possible tasks that may be performed to achieve the particular goal. From the resource library 220, the task creation sub-system 202 may automatically identify any third-party resources 126 previously utilized to generate tasks for similarly-situated members and/or for similar goals. As noted above, the task facilitation service 102 may partner with various organizations (e.g., publishers, clubs, affinity groups, etc.) that may provide or otherwise aggregate information related to different hobbies and intents that may be associated with different goal categories and types. From these one or more third-party resources 126, the task creation sub-system 202 may identify known regimens, learning plans, classes, and the like that may be implemented in order to achieve the stated goal. The task creation sub-system 202 may automatically process this information from the one or more third-party resources 126 to generate individual tasks that may be performed by the member 110, representative 104, and/or third-party services or other services/entities associated with the task facilitation service to achieve the stated goal within the desired timeframe. For instance, if an identified regimen that is publicized and is recommended for weight loss over a period of a year, and the stated goal defined in the new project has a corresponding timeframe of a year, the task creation sub-system 202 may automatically parse the identified regimen to identify a possible set of tasks that may be performed over the coming year to achieve the stated goal. Each task may serve as an increment of the identified regimen, whereby the progress towards achieving the stated goal may be evaluated at the end of a given allotted time for completion of the task.

In an embodiment, the task creation sub-system 202 further allows the representative 104 to manually generate one or more tasks for the project associated with the stated goal. For instance, the task creation sub-system 202 may provide an interface to the representative 104 through which the representative 104 may generate one or more tasks for the new project that may be presented to the member through the interface associated with the particular goal. For instance, if the representative 104 has knowledge regarding the particular goal that is to be achieved, the representative 104 can manually define a regimen or other plan for achieving this goal. This regimen or other plan may include a set of tasks that may be performed by the member 110, representative 104, and/or third-party services or other services/entities associated with the task facilitation service in order to achieve the stated goal. As an illustrative example, if the member's goal is to run a marathon in the coming year, and the representative 104 has previously trained for a marathon and is aware of the training rigors involved, the representative 104 may create a custom plan for the member 110 that may allow the member 110 to train appropriately for a marathon. For the member's goal to run a marathon in the coming year, the representative 104 may generate, via the task creation sub-system 202, a task entitled “interval training followed by one mile run.” For this task, the representative 104 may indicate that the timeframe for completion of the task is one hour, as this is the amount of time that may be required for the member 110 to complete the task. Further, the representative 104 may indicate a completion date for the task in accordance with the overall timeframe for achieving the goal. For example, if the timeframe for achieving the goal is twelve months, the representative 104 may indicate a specific date for completion of the task in order for the member 110 to be on track for achieving the goal within the stated twelve month timeframe.

In an embodiment, the task creation sub-system 202 can provide the representative 104 with access to the third-party resources 126 via the resource library 220 to allow the representative 104 to query these third-party resources 126 to identify possible tasks that may be added to the new project for achieving the stated goal. Based on the representative's review of these third-party resources 126, the representative 104 may manually generate a set of tasks corresponding to any training plans or other information provided by these third-party resources 126 for achieving the stated goal. Additionally, using these third-party resources 126, the representative 104 may identify a final task for the new project corresponding to the stated goal that may serve as an indicator of whether the stated goal was achieved. For example, if the member's stated goal is to run a marathon in the coming year, the representative 104 may review the third-party resources 126 to identify a marathon in the coming year and within the member's geographic area that the member 110 may participate in once the prior set of tasks for the new project are completed successfully. The representative 104 may generate a new task corresponding to this marathon and for the new project. The new task, if completed, may indicate the member's success in achieving the stated goal.

In an embodiment, the task creation sub-system 202 can use the resource library 220 maintained by the task facilitation service to identify one or more tasks associated with the new project that may be recommended to the representative 104. For example, if the task creation sub-system 202 identifies a goal related to the member's indication that it wishes to run a marathon in the upcoming year, the task creation sub-system 202 may automatically query the resource library 220 to identify any tasks associated with the stated goal of running a marathon in the upcoming year. In some instances, the query to the resource library may include member attributes from the member profile associated with the member 110 and stored in the user datastore 210. This may allow the task creation sub-system 202 to identify any tasks that may have been performed or otherwise proposed to similarly-situated members (e.g., members in similar geographic locations, members having similar attributes to that of the present member, etc.) for similar goals. In an embodiment, the task creation sub-system 202 uses a machine learning algorithm or other artificial intelligence to identify the tasks that may be recommended to the representative 104 for an identified project. For example, the task creation sub-system 202 may identify, from the aforementioned resource library 220, any tasks that may be associated with the identified project. The task creation sub-system 202 may process the identified tasks and the member profile from the user datastore 210 using the machine learning algorithm or other artificial intelligence to determine which of the identified tasks may be recommended to the representative 104 for presentation to the member 110 as a proposal option for completion of the project associated with the stated goal.

In an embodiment, the task creation sub-system 202 can generate different groupings of tasks for a particular project corresponding to a stated goal. Each grouping of tasks may correspond to a particular method for achieving the stated goal. For instance, if the stated goal for a member 110 is to run a marathon in the upcoming year, the task creation sub-system 202 may identify (such as through use of the machine learning algorithm/artificial intelligence, information from the resource library 220, and/or information from third-party resources 126) different groupings of tasks for different training plans that may be implemented to train the member 110 for running a marathon in the upcoming year. The different groupings of tasks may be generated based on their source. For instance, a grouping of tasks may correspond to tasks generated using information from third-party resources 126, whereas a different grouping of tasks may correspond to tasks generated manually by the representative 104. Further, myriad groupings of tasks may be generated based on the different methods identified from the resource library 220, third-party resources 126, from the representative 104, and/or from reviewing tasks associated with similar goals for similarly-situated members of the task facilitation service.

The task recommendation system 106 may further include a task ranking sub-system 206, which may be configured to rank the set of tasks generated by the representative 104 and/or the task creation sub-system 202 for completion of the project associated with the stated goal. The task ranking sub-system 206 may be implemented using a computer system or as an application or other executable code implemented on a computer system of the task recommendation system 106. The task ranking sub-system 206 may rank the different groupings of tasks corresponding to the different methods identified for achieving the stated goal. This ranking may be generated based on the likelihood of the member 110 selecting a particular grouping of tasks (e.g., a particular method or plan) for accomplishing the stated goal.

In an embodiment, the task ranking sub-system 206 provides a ranked list of the groupings of tasks that may be recommended to the member 110 to a task selection sub-system 204. The task selection sub-system 204 may be implemented using a computer system or as an application or other executable code implemented on a computer system of the task recommendation system 106. The task selection sub-system 204 may be configured to select, from the ranked list of the groupings of tasks, which groupings of tasks corresponding to different methods for achieving the stated goal may be recommended to the member 110 by the representative 104. For instance, if the application or web portal provided by the task facilitation service is configured to present, to the member 110, a limited number of task recommendations from the ranked list of the groupings of tasks, the task selection sub-system 204 may process the ranked list and the member's profile from the user datastore 210 to determine which grouping recommendations should be presented to the member 110. In some instances, the selection made by the task selection sub-system 204 may correspond to the ranking of the groupings of tasks in the list. Alternatively, the task selection sub-system 204 may process the ranked list of the groupings of tasks, as well as the member's profile and the member's existing tasks (e.g., tasks in progress, tasks accepted by the member 110, etc.), to determine which groupings of tasks may be recommended to the member 110.

The task selection sub-system 204 may provide, to the representative 104, a listing of the different groupings of tasks that may be recommended to the member 110 for the project associated with the stated goal. The representative 104 may review this listing to determine which groupings of tasks may be presented to the member 110 via the application or web portal provided by the task facilitation service. For instance, the representative 104 may review the groupings of tasks recommended by the task selection sub-system 204 and select one or more of these groupings for presentation to the member 110 as proposal options for completing the project associated with the stated goal. In some instances, the one or more groupings of tasks may be presented to the member 110 according to the ranking generated by the task ranking sub-system 206 and refined by the task selection sub-system 204. Alternatively, the one or more groupings of tasks may be presented according to the representative's understanding of the member's own preferences. Through an interface associated with the particular goal, the member 110 may select a grouping of tasks that may be performed for completing the project associated with the stated goal.

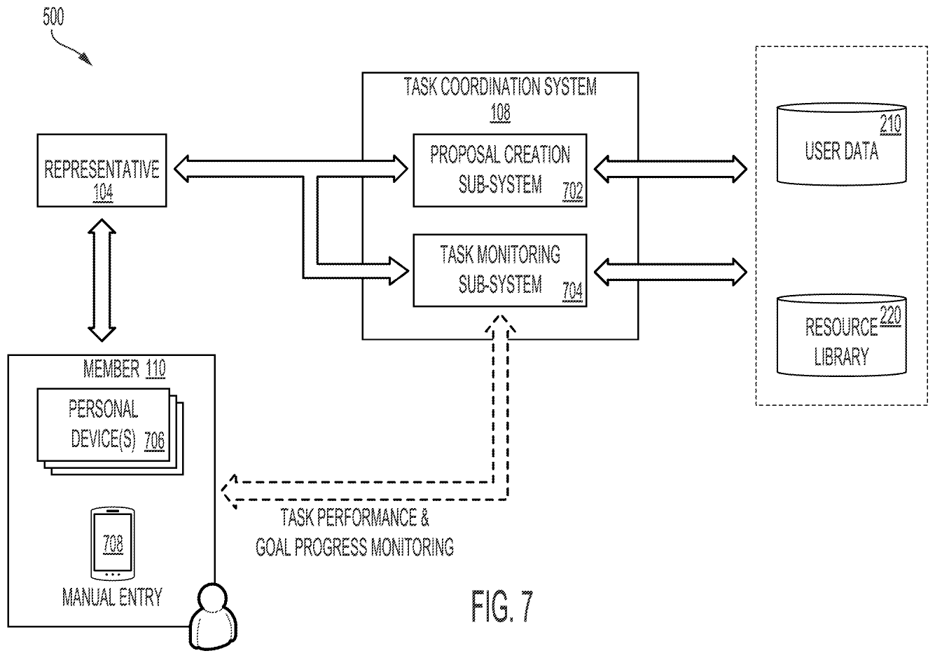

In an embodiment, the representative 104 can review the provided listing of the groupings of tasks from the task selection sub-system 204 and select one or more groupings of tasks that may be used to create one or more proposal options to be included in a proposal to the member 110 for completion of the project associated with the goal. As described in greater detail herein in connection with FIG. 7, the representative 104 can generate a proposal for achieving the stated goal, whereby the proposal may provide, amongst other things, a list of options for different ways that the goal may be achieved. A proposal may include one or more proposal options, wherein a proposal option may include a grouping of tasks that may be performed to achieve the stated goal within a given timeframe. The various options in a proposal may be presented to the member 110 through the interface corresponding to the particular goal presented via the web portal or application provided by the task facilitation service. Based on the member responses to the various options presented in the proposal, the representative 104 may present tasks associated with a selected option via the project interface corresponding to the particular goal, through which the member 110 may review the project corresponding to the goal and the tasks corresponding to the selected proposal option for the particular project.

In an embodiment, the task selection sub-system 204 monitors the communications session between the member 110 and the representative 104 to collect data with regard to member selection of proposal options corresponding to different groupings of tasks for the project associated with the stated goal. For instance, the task selection sub-system 204 may process messages corresponding to groupings of tasks presented to the member 110 by the representative 104 over the communications session corresponding to the particular goal to determine a polarity or sentiment corresponding to each grouping of tasks. For example, if a member 110 indicates, in a message to the representative 104, that it would prefer not to receive any recommendations corresponding to groupings of tasks that require the member 110 to allocate a significant amount of time for each task (e.g., greater than an hour, etc.), the task selection sub-system 204 may ascribe a negative polarity or sentiment to groupings of tasks that include tasks that require a significant amount of time to complete. Alternatively, if a member 110 selects a proposal option corresponding to a grouping of tasks for achieving the goal and/or indicates in a message to the representative 104 that a recommendation of this grouping of tasks was a great idea, the task selection sub-system 204 may ascribe a positive polarity or sentiment to this grouping of tasks. In an embodiment, the task selection sub-system 204 can use these responses to groupings of tasks recommended to the member 110 to further train or reinforce the machine learning algorithm or artificial intelligence utilized by the task ranking sub-system 206 to generate task recommendations that can be presented to the member 110 and other similarly-situated members of the task facilitation service. Further, the task selection sub-system 204 may update the member profile associated with the member 110 within the user datastore 210 to update the member's preferences and known behavior characteristics based on the member's selection of groupings of tasks from those recommended by the representative 104 and/or sentiment with regard to the groupings of tasks recommended by the representative 104.

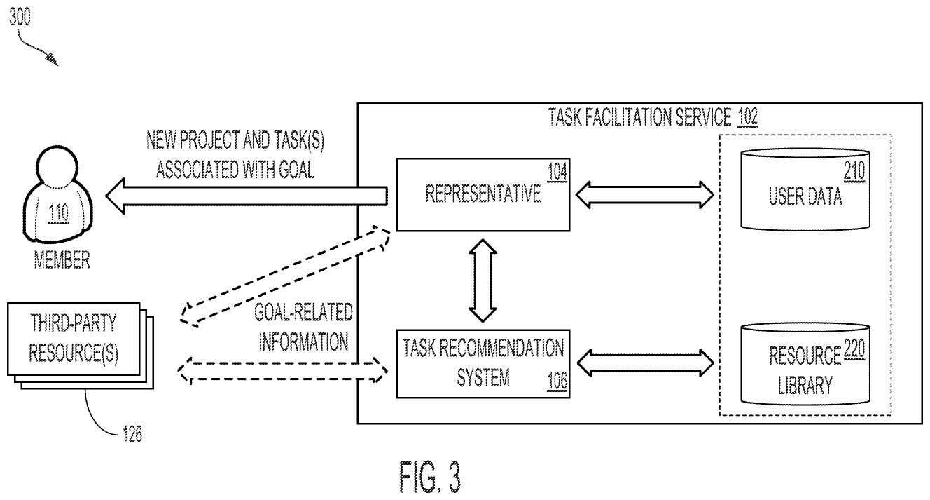

FIG. 3 shows an illustrative example of an environment 300 in which new projects and tasks associated with a particular member goal are provided to a member 110 by a representative 104 associated with the task facilitation service 102 based on a ranking of tasks in accordance with at least one embodiment. As noted above, the task recommendation system 106 can generate a ranked list of task groupings that may be used by the representative 104 to generate different proposal options for completing a project associated with a particular goal that may be presented to the member 110. Alternatively, the task recommendation system 106 may automatically select, from the ranked list of task groupings, one or more task groupings that may be presented to the member 110 for completion of the project associated with the stated goal.

As noted above, the task recommendation system 106 may generate different task groupings corresponding to different methods that may be performed by a member 110, representative 104, and/or third-party services or other services/entities associated with the task facilitation service 102 to accomplish a particular goal defined by the member 110. A representative 104 may provide information obtained from a member 110 regarding a particular goal defined by the member 110 to the task recommendation system 106 to dynamically, and in real-time, generate a project comprising a set of tasks that may be performed within a pre-defined timeframe for achieving the goal. In an embodiment, the task recommendation system 106 can automatically, and in real-time, process messages between the member 110 and the representative 104 as they are being exchanged to identify a goal for which a project may be defined for achieving the goal. For instance, the task recommendation system 106 may utilize NLP or other artificial intelligence to evaluate exchanged messages or other communications from the member 110 to identify any goals that the member 110 would like to achieve. In some instances, the task recommendation system 106 may utilize historical data corresponding to previously identified goals for similarly-situated members and corresponding messages from these members from the user datastore 210 to train the NLP or other artificial intelligence to identify possible goals.

In an embodiment, if the task recommendation system 106 identifies, based on the real-time processing of messages between the member 110 and the representative 104, one or more goals that the member 110 may wish to achieve, the task recommendation system 106 may present these identified one or more goals to the representative 104 through an application or web portal provided to the representative 104 by the task facilitation service 102. The representative 104 may review the identified one or more goals and determine which of these goals are to be presented to the member 110. For instance, based on the representative's knowledge of the member 110, the representative 104 may select one or more goals that may be appealing to the member 110. In some instances, in order to not overwhelm the member 110 with various goals, the representative 104 may select a subset of the goals provided by the task recommendation system 106 that may be presented to the member 110. If the member 110 selects a particular goal that it wishes to pursue, the representative 104 may indicate that it can assist the member 110 in achieving this goal.

As noted above, the task recommendation system 106 may provide users (e.g., a member 110, a representative 104, etc.) with various templates that may be used to generate a new project corresponding to a particular goal that the member 110 wishes to achieve. For instance, the task recommendation system 106 may maintain, in the resource library 220, project templates for different goal types or categories. Each project template may include different data fields for defining the project, whereby the different data fields may correspond to the goal type or category for the project being defined. A representative 104 may provide goal information via these different data fields to define the project that may be submitted to the task recommendation system 106. In some instances, the task creation sub-system 202 can automatically populate one or more data fields from a selected project generation template based on information provided in the member profile associated with the member 110, as noted above.

In some instances, a member 110 can manually generate a new project via the task recommendation system 106. For instance, if the member 110 determines that they have a goal that they wish to achieve and for which they would like to receive assistance from the representative 104 and the task facilitation service 102, the member 110 may access, through an interface provided by the task facilitation service 102, the resource library 220 to obtain a template that may be used by the member 110 to define a new project corresponding to the goal. Once the member 110 has defined the new project for the goal, the task recommendation system 106 may transmit a notification to the representative 104 indicating that the member 110 has defined a new project corresponding to a goal that the member 110 wishes to achieve. This may cause the representative 104 to evaluate the new project and proceed to generate one or more tasks that may be added to the project for achieving the goal.

The task recommendation system 106 may allow the representative 104 to generate one or more tasks for the newly created project corresponding to the goal and that may be presented to the member over a communications session between the member 110 and the representative 104 facilitated by the task facilitation service 102 for the particular goal. For instance, the representative 104 may provide a name for each task, any known parameters of a task (e.g., timeframes, task operations to be performed, etc.), and the like. For a given task, the representative 104 may indicate an estimated amount of time required for completion of the task. Further, the representative 104 may indicate an allotted amount of time for completion of the task in accordance with the overall timeframe for achieving the goal. For example, if the timeframe for achieving the goal is twelve months, the representative 104 may indicate a specific date for completion of the task in order for the member 110 to be on track for achieving the goal within the stated twelve month timeframe.

As noted above, the task recommendation system 106 may also automatically generate tasks that can be added to the project for achieving the stated goal. For instance, the task recommendation system 106 may use the goal, information corresponding to the member 110 from the user datastore 210 (e.g., the member profile), and historical data corresponding to goals and corresponding tasks performed by similarly-situated members from the user datastore 210 as input to a machine learning algorithm or artificial intelligence to identify tasks that may be performed to achieve the member's goal. Based on the characteristics of the goal, characteristics of the member 110, and data corresponding to these similarly-situated members, the task recommendation system 106 may automatically generate tasks that may be performed within the stated timeframe to achieve the goal.

In some instances, the task recommendation system 106 can automatically query the resource library 220 and/or one or more third-party resources 126 to identify possible tasks that may be performed in order to achieve a new goal. As noted above, the task facilitation service 102 may partner with various organizations that provide or otherwise aggregate information related to different hobbies or interests that may be associated with different goal categories. From these one or more third-party resources 126, the task recommendation system 106 may identify known regimens, learning plans, classes, and the like that may be implemented in order to achieve the stated goal. In some instances, the task recommendation system 106 may query the resource library 220 to identify any third-party resources 126 and/or previously identified regimens, learning plans, classes, and the like associated with similar goals. The task recommendation system 106 may automatically process this information from the resource library 220 and/or one or more third-party resources 126 to generate individual tasks that may be performed by the member 110, representative 104, and/or third-party services or other services/entities associated with the task facilitation service 102 to achieve the stated goal within the desired timeframe. In some instances, these individual tasks may be grouped into task groupings according to the different methods that may be implemented for achieving the goal. For instance, if the task recommendation system 106 identifies various methods that may be implemented to achieve the same goal, the task recommendation system 106 may automatically generate tasks corresponding to each available method and group these tasks into a task grouping corresponding to the method.

As noted above, the task recommendation system 106 may also allow the representative 104 to manually generate tasks for the new project. For instance, the task recommendation system 106 may provide an interface to the representative 104 through which the representative 104 may generate one or more tasks for the new project that may be presented to the member over the communications session established between the member 110 and the representative 104 for the particular goal. Further, the task recommendation system 106 can provide the representative 104 with access to the resource library 220 and the third-party resources 126 to allow the representative 104 to query the resource library 220 and these third-party resources 126 to identify possible tasks that may be added to the new project for achieving the stated goal. Based on the representative's review of the resource library 220 and these third-party resources 126, the representative 104 may manually generate a set of tasks corresponding to any training plans or other information provided by these third-party resources 126 for achieving the stated goal. Additionally, using the resource library 220 and these third-party resources 126, the representative 104 may identify a final task for the new project corresponding to the stated goal that may serve as an indicator of whether the stated goal was achieved.

The task recommendation system 106, as noted above, may also provide a ranking of the various task groupings identified for a particular project. For instance, the task recommendation system 106 may rank the different task groupings corresponding to the different methods identified for achieving the goal based on the likelihood of the member 110 selecting a particular task grouping for accomplishing the stated goal. The task recommendation system 106 may select, from the ranked list of the task groupings, one or more task groupings (e.g., methods for accomplishing the goal) that may be recommended to the member 110 by the representative 104. In some instances, the selection made by the task recommendation system 106 may correspond to the ranking of the task groupings in the list. Alternatively, the task recommendation system 106 may process the ranked list of the groupings of task groupings, as well as the member profile associated with the member 110 and the member's existing tasks from the user datastore 210, to determine which task groupings may be recommended to the member 110.

As noted above, the task recommendation system 106 may provide, to the representative 104, a listing of the different task groupings that may be recommended to the member 110 for the project associated with the stated goal. The representative 104 may review this listing to determine which task groupings may be presented to the member 110 via the application or web portal provided by the task facilitation service 102. In some instances, the one or more task groupings may be presented to the member 110 according to the ranking generated by the task recommendation system 106. Alternatively, the one or more task groupings may be presented according to the representative's understanding of the member's own preferences. Through an interface associated with the particular goal, the member 110 may select a task grouping that may be performed for completing the project associated with the stated goal. As described in greater detail herein, the different task groupings may be presented within a proposal generated by the representative 104, whereby each task grouping selected for presentation to the member 110 may be presented as a corresponding proposal option within the proposal. Further, the proposal options may be presented according to the ranking provided by the task recommendation system 106 or as determined by the representative 104.

In an embodiment, the representative's manual selection of one or more task groupings for the project, as well as member feedback related to the presentation of these one or more task groupings, may be recorded in the user datastore 210 and used by the task recommendation system 106 to further train a machine learning algorithm or artificial intelligence used to rank available task groupings for similar goals and/or for similarly-situated members. As an illustrative example, if the representative 104 selects a particular task grouping (e.g., method for achieving the goal) that has a relatively low ranking as determined by the task recommendation system 106, and the member 110 responds positively to this particular task grouping (e.g., the member 110 selects the proposal option corresponding to the task grouping for the project, the member 110 provides feedback indicating a positive reaction to the task grouping, etc.), the task recommendation system 106 may use this data to train the machine learning algorithm or artificial intelligence to more accurately rank task groupings for similar goals and for similarly-situated members.

In an embodiment, the task recommendation system 106 can further train the machine learning algorithm or artificial intelligence used to rank task groupings for different goals based on the member's interactions with the various proposal options presented with the proposal for completing a project associated with a stated goal. For instance, if a member 110 outright rejects a particular proposal option corresponding to a task grouping for achieving a goal, the task recommendation system 106 may record the member's rejection of this proposal option within the member profile stored in the user datastore 210. The task recommendation system 106 may use this rejection to further train the machine learning algorithm or artificial intelligence used to rank different task groupings for similar goals and/or for similarly-situated members such that similar task groupings are less likely to be ranked highly for similar goals and/or similarly-situated members. Further, if the member 110 rejects a presented proposal option corresponding to a task grouping, the representative 104 or the task recommendation system 106 can solicit feedback from the member 110 with regard to its decision to reject the proposal option. The presented proposal and corresponding proposal options, the member profile, and any feedback provided by the member 110 may be processed using the machine learning algorithm or artificial intelligence to further train the machine learning algorithm or artificial intelligence to provide task groupings for similar goals and/or for similar situated members that are more likely to be received positively.

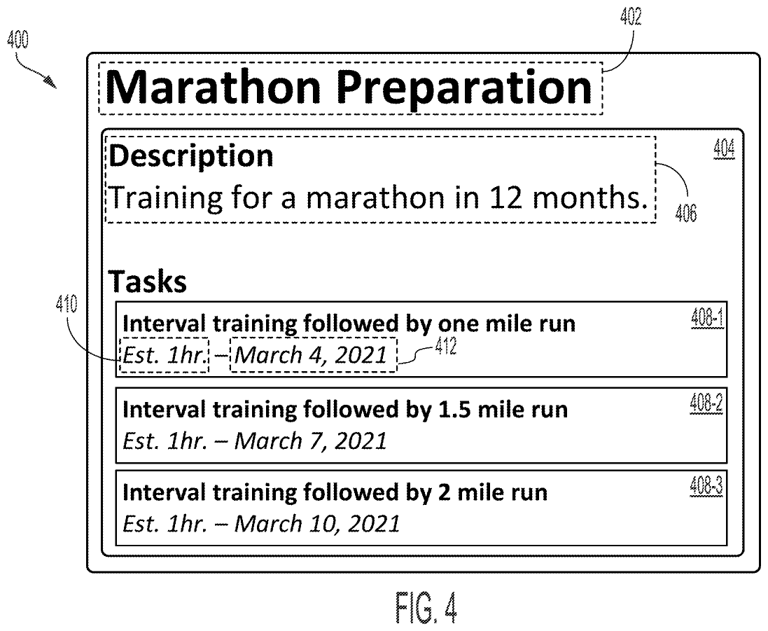

FIG. 4 shows an illustrative example of a project 400 including a set of corresponding tasks 408-1-408-3 performable to achieve a member goal presented to a member via an interface of the task facilitation service in accordance with at least one embodiment. A project 400 can include various elements that allow for a member to determine the parameters of the various tasks 408-1-408-3 that may be performed to achieve a particular goal for which the project 400 is being presented. For example, as illustrated in FIG. 4, the project 400 can include a descriptive title 402 for the project 400 (e.g., “Marathon Preparation”). The descriptive title 402 may be generated by the member, the representative, or the task recommendation system when generating the template corresponding to the project 400 associated with a particular goal. For instance, a member or representative may access an interface provided by the task facilitation service to manually generate a new project that may correspond to a goal that the member wishes to achieve. Through the interface, the member or representative may be prompted to provide a new descriptive title 402 for the project 400.

In an embodiment, the task recommendation system can use a machine learning algorithm or artificial intelligence to generate the descriptive title 402 for the project 400. For instance, the task recommendation system may use, as input, information provided by the member and/or the representative (e.g., information provided by the member and/or the representative manually, messages exchanged between the member and representative for a particular goal, etc.) and any feedback from members of the task facilitation service related to historical projects/goals provided to these members to determine a descriptive title 402 for the project 400. The machine learning algorithm or artificial intelligence may be trained using supervised training techniques. For instance, a dataset of projects, corresponding descriptive titles, and feedback related to the descriptive titles and projects can be selected for training of the machine learning algorithm or artificial intelligence. The machine learning algorithm or artificial intelligence may be evaluated to determine, based on the sample inputs supplied to the machine learning algorithm or artificial intelligence, whether the machine learning algorithm or artificial intelligence is producing accurate descriptive titles for projects corresponding to different goals. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from members and representatives with regard to the descriptive titles provided by the machine learning algorithm or artificial intelligence for each project associated with a goal. For instance, if a representative or member indicates that a descriptive title for a presented project does not appear to accurately correspond to the underlying goal that is to be achieved, the machine learning algorithm or artificial intelligence may be modified using this feedback to increase the likelihood of accurate descriptive titles being generated by the machine learning algorithm or artificial intelligence.

In an embodiment, if the task recommendation system automatically, and in real-time, identifies a goal specified by the member as messages are exchanged between the member and representative, the task recommendation system can automatically generate a new project 400 and provide a descriptive title 402 based on the one or more messages that were indicative of this new goal. In some instances, the task recommendation system can provide a proposed descriptive title and corresponding messages associated with the identified goal to the representative. This may allow the representative to review the proposed descriptive title and the corresponding messages to determine whether the proposed descriptive title is acceptable for the project 400 or whether a different descriptive title is to be used for the project 400. Based on the representative's review, the task recommendation system may update the machine learning algorithm or artificial intelligence described above to increase the likelihood of accurate descriptive titles being generated by the machine learning algorithm or artificial intelligence.

A project 400 presented to a member may further include, within a project window 404, a short description 406 related to the project 400 being presented to the member for accomplishing a corresponding goal. The short description 406 may be generated such that it is easily digestible for members of the task facilitation service. For instance, the short description 406 may be limited to a single sentence providing a description of the goal that is to be achieved at the end of the project 400. Additionally, or alternatively, the short description 406 may be limited to a set number of characters (e.g., 100 characters, etc.) to allow a member to quickly determine the scope of the project 400. The short description 406 may be provided by a representative based on their knowledge of the goal that is to be achieved. For instance, the representative may review information provided by the member for a particular goal and generate a summary of the particular goal based on this information. This summary may be included in the template for the particular project in the form of the short description 406. Thus, when the project 400 is presented, the task recommendation system or representative may insert this short description 406 from the template into the project 400.

Similar to the creation of the descriptive title 402, the task facilitation service can use a machine learning algorithm or artificial intelligence to generate the short description 406 by using, as input, information provided by the member and/or the representative and any feedback from members of the task facilitation service related to historical projects/goals provided to these members. As output, the machine learning algorithm or artificial intelligence can provide the short description 406 that is to be provided with a corresponding project 400 when presented to a member. The short description 406 may include additional information that may be of relevance for the member. For instance, if the project 400 corresponds to a goal of running a marathon in the coming year, the short description 406 may indicate the parameters of the goal (e.g., timeframe, etc.) to allow the member to readily determine the scope of the project 400 and the corresponding goal.

The project 400 may further specify one or more tasks 408-1-408-3 that may be associated with the project 400 and that may be performed to achieve the underlying goal. The one or more tasks 408-1-408-3 presented via the project window 404 of the project 400 may correspond to a selected proposal option. As noted above, if the member selects, from a proposal presented to the member, a particular proposal option that includes a set of tasks performable by the member, representative, and/or one or more third-party services or other services/entities associated with the task facilitation service to achieve the stated goal, the task coordination system of the task facilitation service can provide the project 400 for the stated goal that includes one or more tasks that are to be performed to achieve the stated goal. In an embodiment, the number of tasks presented for the project 400 may be determined based on known characteristics of the member (e.g., member preferences for level of detail required for different projects or tasks, a predefined number of tasks that are to be displayed to the member, etc.). For example, if a project 400 corresponding to marathon training over the coming year includes three tasks per week over the coming year, the task coordination system may determine, based on the known characteristics of the member, how many of these tasks may be displayed via the interface at any given time. As another example, the number of tasks presented within the project window 404 may correspond to a maximum number of overall tasks that are presentable to the member for each project. For instance, if presentation of a project is limited to a particular number of tasks for the member, the project window 404 may be updated to include this number of tasks. However, the member may be presented with an option to review all tasks related with the project 400 if so desired.

In some instances, the tasks 408-1-408-3 presented in the project window 404 may be ordered according to an ordering in which these tasks are to be performed. For instance, as illustrated in FIG. 4, a first task 408-1 that a member is to perform first may be presented at the top of a list of tasks to indicate that this task 408-1 is to be performed first. Subsequent tasks 408-2 and 408-3 may be presented in the order in which these tasks are to be performed after the first task 408-1 is completed. The ordering of these tasks 408-1-408-3 may correspond to the method or plan implemented for achieving the underlying goal within the indicated timeframe. When a task is completed, the task may be removed from the project 400 and the remaining tasks may be moved up in the ordering such that the next task that is to be performed is presented at the top of the list of tasks via the project window 404. As noted above, the task coordination system may update the project window 404 to provide a graphical indication that the task has been completed. For example, the task coordination system may move the completed task to a section of the project window 404 corresponding to completed tasks (e.g., a “Completed To-Dos” section of the project window 404 (not shown), etc.).

Each task 408-1-408-3 may provide additional information that may be used by the member to determine the expected time required by the member, representative, or third-party service to perform the task and the allotted time or deadline for performing and completing the task. For example, as illustrated in FIG. 4, a task may indicate a task duration 410, which may correspond to the expected time required for performance of the task. As illustrated in FIG. 4, the task 408-1, which provides the member with a task to perform interval training followed by a one-mile run, may specify as a task duration 410 that it may take the member an hour to complete the task 408-1. This may allow the member to allocate this amount of time in a given day to perform the particular task.

In addition to providing a task duration 410, each task presented in the project window 404 may indicate a deadline 412 for completion of the corresponding task. For example, for task 408-1, the member may be provided with a deadline of Mar. 4, 2021 to complete the task. This may provide the member with flexibility to determine a best time to perform the stated task. The deadline 412 for each task may be determined based on the parameters for completing the project 400 according to a timeframe specified for achieving the goal. Thus, in order for the stated goal to be achieved within the predefined timeframe, each task 408-1-408-3 associated with the project 400 may need to be performed according to their respective deadlines 412 or other temporal limits in order to ensure that the requisite progress is being made towards achieving the stated goal.

As noted above, the task coordination system may, in real-time, process messages as they are exchanged between the member and the representative through a communications session specific to the current task to determine whether the current task for the project 400 has been performed or is in the process of being performed. If the task is being performed by a third-party service, the task coordination system may record any information provided by the third-party services with regard to the performance of the task. If the current task for the project 400 has been completed, the task coordination system may indicate that the task has been completed and update the project 400 to present the next task that is to be performed for achieving the stated goal as the current task that is to be performed by the member, representative, and/or one or more third-party services. This process may continue until the tasks associated with the project 400 are completed and the stated goal is presumed achieved. Further, as noted above, if the task coordination system determines that the current task has not been completed within the allotted time for the task, the task coordination system may determine whether the stated goal can still be achieved within the original timeframe defined for the goal. For instance, the task coordination system may automatically review the remaining set of tasks for the project 400 to determine whether these tasks may be shifted to provide more time for completion of the current task without impacting the overall timeframe for achieving the goal. If the task coordination system determines that the remaining set of tasks may be shifted to provide more time for completion of the current task, the task coordination system may automatically, and dynamically, update the current task 408-1-408-3 to provide a new deadline 412 for completion of the task. This may provide the member, representative, and/or third-party services performing the task more time to complete the task. Any other tasks associated with the project 400 may also be shifted accordingly, if needed.

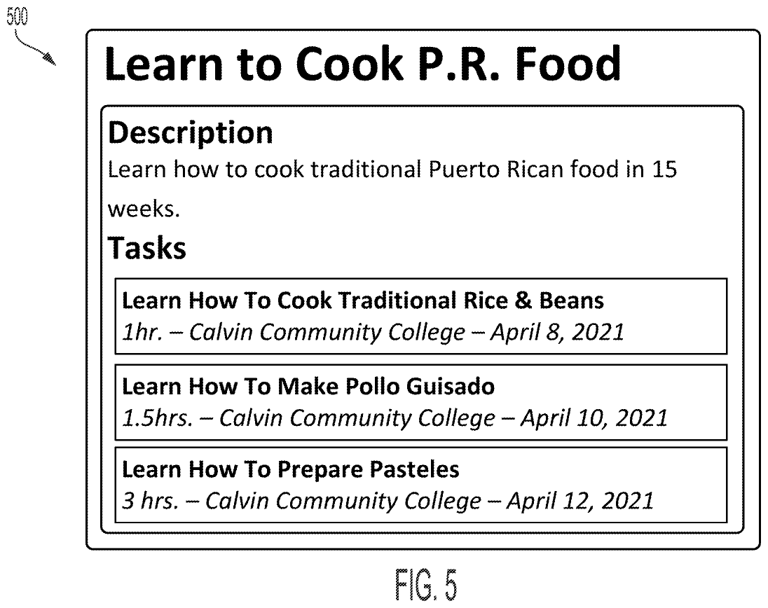

FIG. 5 shows an illustrative example of another project 500 including a set of corresponding tasks performable to achieve a member goal presented to a member via an interface of the task facilitation service in accordance with at least one embodiment. The project 500 may include similar elements to those described above in connection with the project 400 illustrated in FIG. 4. For instance, the project 500 may include a descriptive title, a short description of the goal for which the project 500 was created, and a corresponding set of tasks that may be performed in order to accomplish the goal and complete the project 500. Each task associated with the project 500 may indicate an estimated amount of time required for completion of the task and a deadline for performance of the task.

As illustrated in FIG. 5, the project 500 may correspond to a goal related to learning how to cook Puerto Rican food in the span of 15 weeks. To accomplish this goal, the member may be required to attend classes at a culinary school or at a local community college to learn how to prepare different Puerto Rican dishes. As such, each task associated with the project 500 may correspond to individual classes at a culinary school or at a local community college that the member may be required to attend in order to complete the task. Further, each task presented via the project 500 may indicate the location where the task is to be performed (e.g., Calvin Community College, where the culinary classes are being conducted).

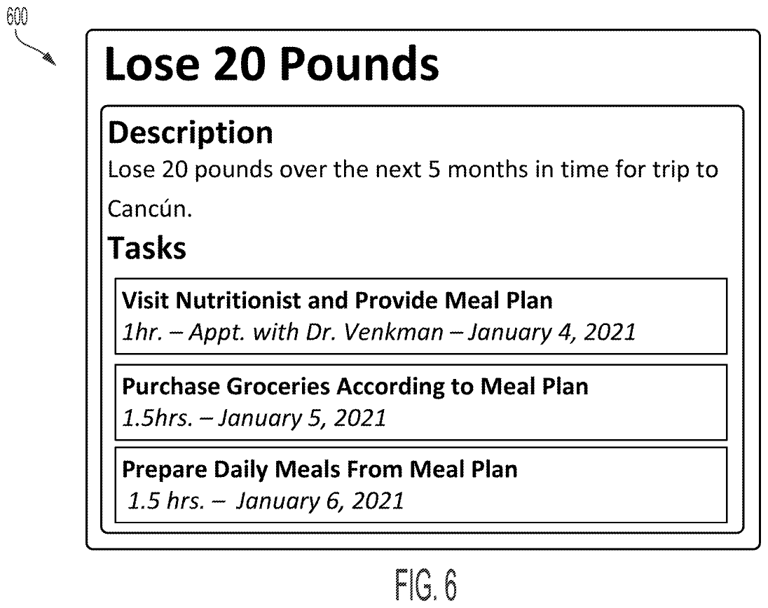

FIG. 6 shows an illustrative example of another project 600 including a set of corresponding tasks performable to achieve a member goal presented to a member via an interface of the task facilitation service in accordance with at least one embodiment. Similar to the projects 400 and 500 described above in connection with FIGS. 4 and 5, respectively, the project 600 may include a descriptive title, a short description of the goal for which the project 600 was created, and a corresponding set of tasks that may be performed in order to accomplish the goal and complete the project 600. Each task associated with the project 600 may indicate an estimated amount of time required for completion of the task and a deadline for performance of the task.

As illustrated in FIG. 6, the project 600 may correspond to a goal related to losing a particular amount of weight over the next 5 months in anticipation of a trip to Cancún. To accomplish this particular goal, the member may be presented with a task related to visiting a nutritionist to obtain a meal plan and to provide the meal plan to their assigned representative and/or the task facilitation service. The representative and/or the task facilitation service may use this meal plan to monitor the member's progress with regard to later tasks associated with the project 600. For instance, for a particular task related to preparing daily meals according to the meal plan, the representative may guide the member with regard to what ingredients may be required to prepare these daily meals and coordinate with the member to ensure that the member has the requisite groceries and other supplies for these daily meals.

FIG. 7 shows an illustrative example of an environment 700 in which a task coordination system 108 assigns and monitors performance of tasks associated with a particular goal by a representative 104 and/or a member 110 in accordance with at least one embodiment. In the environment 700, a representative 104 may access a proposal creation sub-system 702 of the task coordination system 108 to generate a proposal for different task groupings that may be performed to achieve a particular goal. The proposal creation sub-system 702 may be implemented using a computer system or as an application or other executable code implemented on a computer system of the task coordination system 108. As noted above, the representative 104 may be provided with a listing of different task groupings that may be recommended to the member 110 for a project associated with the stated goal. The representative 104 may review this listing of the different task groupings to determine which task groupings may be presented to the member 110. Once the representative 104 has determined which task groupings are to be proposed to the member 110, the representative, via the proposal creation sub-system 702, may generate a proposal that may be presented to the member 110 highlighting the various task groupings that may be used to achieve the stated goal.

A proposal may include one or more options presented to a member 110 that may be created and/or collected by a representative 104 while researching a given task. In some instances, a representative 104 may access, via the proposal creation sub-system 702, one or more templates that may be used to generate these one or more proposals. For example, the proposal creation sub-system 702 may maintain, within the resource library 220 or internally, proposal templates for different project or goal types, whereby a proposal template for a particular project or goal type may include various data fields associated with the project or goal type.

In an embodiment, the data fields within a proposal template can be toggled on or off to provide a representative 104 with the ability to determine what information is to be presented to the member 110 in a proposal. The representative 104, based on its knowledge of the member's preferences, may toggle on or off any of these data fields within the template. For example, if the representative 104 has established a relationship with the member 110 whereby the representative 104, with high confidence, knows that the member trusts the representative 104 in selecting reputable businesses for its tasks, the representative 104 may toggle off a data field corresponding to the ratings/reviews for corresponding businesses from the proposal template. Similarly, if the representative 104 knows that the member 110 is not interested in the location/address of a business for the purpose of the proposal, the representative 104 may toggle off the data field corresponding to the location/address for corresponding businesses from the proposal template. While certain data fields may be toggled off within the proposal template, the representative 104 may complete these data fields to provide additional information that may be used by the proposal creation sub-system 702 to supplement a resource library of proposals maintained by the task coordination system 108.

In an embodiment, the proposal creation sub-system 702 utilizes a machine learning algorithm or artificial intelligence to generate recommendations for the representative 104 regarding data fields that may be presented to the member 110 in a proposal. The proposal creation sub-system 702 may use, as input to the machine learning algorithm or artificial intelligence, a member profile or model associated with the member 110 from the user datastore 210, historical task data for the member 110 from the member profile, and information corresponding to the project associated with the stated goal for which a proposal is being generated (e.g., a goal type or category, etc.). The output of the machine learning algorithm or artificial intelligence may specify which data fields of a proposal template should be toggled on or off. The proposal creation sub-system 702, in some instances, may preserve, for the representative 104, the option to toggle on these data fields in order to provide the representative 104 with the ability to present these data fields to the member 110 in a proposal. For example, if the proposal creation sub-system 702 has automatically toggled off a data field corresponding to the estimated cost for achieving the goal or for any tasks associated with the goal, but the member 110 has expressed an interest in the possible cost involved, the representative 104 may toggle on the data field corresponding to the estimated cost.

Through the proposal creation sub-system 702, the representative 104 can generate one or more proposal options corresponding to the different task groupings that may be performed to achieve the stated goal (as defined in the project). Each proposal option may be generated according to the proposal template for the particular project or goal type associated with the stated goal that is to be achieved. For instance, a proposal option may incorporate the data fields from the proposal template selected for the particular project or goal type associated with the stated goal. The proposal options for the proposal may be organized according to the ranking of the different task groupings as determined by the task recommendation system and/or the representative 104, as noted above. As noted above, the task recommendation system of the task facilitation service may rank the different task groupings according to the likelihood of the member 110 selecting a particular task grouping for accomplishing the stated goal. The task recommendation system may select, from the ranked list of the task groupings, one or more task groupings that may be recommended to the member 110 by the representative 104. In some instances, the selections made by the task recommendation system may correspond to the ranking of the task groupings in the list. Alternatively, the task recommendation system may process the ranked list of the task groupings, as well as the member's profile and the member's existing tasks from the user datastore 210, to determine which task groupings may be provided to the representative 104 as recommendations for the member 110. The representative 104, based on its knowledge of the member 110, may determine whether to generate proposal options according to the ranked list of task groupings or to generate proposal options corresponding to task groupings that may be more appealing to the member 110 based on the representative's knowledge of the member 110.

The proposal options included in the proposal may be organized according to the ranking of the task groupings generated by the task recommendation system and/or the representative's selection and ordering of task groupings according to the representative's knowledge of the member's preferences. For instance, a more prominently presented proposal option (e.g., the first proposal option presented, a proposal option presented as a preferred/recommended option, etc.) may correspond to the highest ranked task grouping selected by the task recommendation system and/or the representative 104. This may allow the member 110 to more readily review the highest ranked or preferred task grouping for the project associated with the stated goal first. The other proposal options may be presented according to the ranking or ordering established by the task recommendation system and/or the representative 104. For instance, for a particular proposal, the representative 104 may generate a recommended option, which may correspond to the task grouping that the representative 104 is recommending for completion of a project associated with the stated goal. Additionally, in order to provide the member 110 with additional options or choices, the representative 104 can generate additional options corresponding to other task groupings that may be performed to complete the project associated with the stated goal. In some instances, if the representative 104 knows that the member 110 has delegated the decision-making with regard to the planning of how best to achieve stated goals to the representative 104, the representative 104 may forego generation of additional proposal options outside of the recommended option. However, the representative 104 may still present, to the member 110, the selected proposal option for completion of the project.

As noted above, the task coordination system 108 maintains a resource library 220 that may be used to automatically populate one or more data fields of a particular proposal template. The resource library 220 may include entries corresponding to businesses and/or products previously used by representatives for proposals related to particular projects and task types or that are otherwise associated with particular project and task types. For instance, when a representative 104 generates a proposal for a project related to learning how to cook Puerto Rican food in Lynnwood, Washington, the proposal creation sub-system 702 may obtain information associated with the culinary school selected by the representative 104 for the task. The proposal creation sub-system 702 may generate an entry corresponding to the culinary school in the resource library 220 and associate this entry with “Puerto Rican food” and “Lynnwood, Washington.” Thus, if another representative identifies a member goal to learn how to cook Puerto Rican food for a member located near Lynnwood, Washington, the other representative may query the resource library 220 for culinary schools near Lynnwood, Washington that may have courses in Puerto Rican cuisine. The resource library 220 may return, in response to the query, an entry corresponding to the culinary school previously selected by the representative 104. If the other representative selects this culinary school, the proposal creation sub-system 702 may automatically populate the data fields of the proposal template with the information available for the culinary school from the resource library 220.

Once the representative 104 has generated a new proposal for the member 110, the representative 104 may present the proposal and the corresponding proposal options to the member 110. Further, the proposal creation sub-system 702 may store the new proposal in the user datastore 210 in association with a member entry in the user datastore 210. In some instances, the representative 104 may transmit a notification to the member 110 to indicate that a proposal has been prepared for a particular project associated with a stated goal and that the proposal is ready for review via the application or web portal provided by the task facilitation service. The proposal presented to the member 110 may indicate the project/goal for which the proposal was prepared, as well as an indication of the one or more proposal options that are being provided to the member 110. For instance, the proposal may include links to the recommended proposal option and to the other options (if any) prepared by the representative 104 for the particular project associated with the stated goal. These links may allow the member 110 to navigate amongst the one or more options prepared by the representative 104 via the application or web portal. In some instances, the representative 104 may transmit the proposal to the member 110 via other communication channels, such as via e-mail, text message, and the like.

In some instances, when a proposal is presented to a member 110, the proposal creation sub-system 702 may monitor member interaction with the representative 104 and with the proposal to obtain data that may be used to further train the machine learning algorithm or artificial intelligence. For example, if a representative 104 presents a proposal without any ratings/reviews for a particular business that is to assist the member 110 in achieving the goal based on the recommendation generated by the proposal creation sub-system 702, and the member 110 indicates (e.g., through messages to the representative 104, through selection of an option in the proposal to view ratings/reviews for the particular business, etc.) that they are interested in ratings/reviews for the particular business, the proposal creation sub-system 702 may utilize this feedback to further train the machine learning algorithm or artificial intelligence to increase the likelihood of recommending presentation of ratings/reviews for businesses selected for similar tasks or task types.

For each proposal option, the member 110 may be presented with information corresponding to the task grouping selected by the representative 104 and corresponding to the data fields selected for presentation by the representative 104 via the proposal creation sub-system 702. In some instances, the member 110 may select what details or data fields associated with a particular proposal are presented via the application or web portal. For example, if the member 110 is presented with the estimated total for each proposal option and the member 110 is not interested in reviewing the estimated total for each proposal option, the member 110 may toggle off this particular data field from the proposal via the application or web portal. Alternatively, if the member 110 is interested in reviewing additional detail with regard to each proposal option (e.g., additional reviews, additional business or product information, etc.), the member 110 may request this additional detail to be presented via the proposal.

As noted above, based on member interaction with a provided proposal, the proposal creation sub-system 702 may further train a machine learning algorithm or artificial intelligence used to determine or recommend what information should be presented to the member 110 and to similarly-situated members for similar projects or goal types. The proposal creation sub-system 702 may monitor or track member interaction with the proposal to determine the member's preferences regarding the information presented in the proposal for the particular task. Further, the proposal creation sub-system 702 may monitor or track any messages exchanged between the member 110 and the representative 104 related to the proposal to further identify the member's preferences. In some instances, the proposal creation sub-system 702 may solicit feedback from the member 110 with regard to proposals provided by the representative 104 to identify the member's preferences. This feedback and information garnered through member interaction with the representative 104 regarding the proposal and with the proposal itself may be used to retrain the machine learning algorithm or artificial intelligence to provide more accurate or improved recommendations for information that should be presented to the member 110 and to similarly-situated members in proposals for similar projects or goal types. The proposal creation sub-system 702 may further use the feedback and information garnered through member interaction with the representative 104 to update a member profile or model within the user datastore 210 for use in determining recommendations for information that should be presented to the member 110 in a proposal.

In an embodiment, if a member 110 accepts a proposal option from the presented proposal, the task coordination system 108 moves the tasks associated with the selected proposal option to an executing state and the representative 104 can proceed to execute on the proposal according to the selected proposal option. For instance, the representative 104 may contact one or more third-party services to coordinate performance of any of the tasks from the selected task grouping that may require assistance from these one or more third-party services according to the parameters defined in the proposal accepted by the member 110. Additionally, or alternatively, if one or more tasks from a selected proposal option (e.g., task grouping) are to be performed by the member 110, the representative 104 may coordinate with the member 110 to ensure that these tasks are being completed successfully by the member 110. In some instances, if a member's performance of one or more tasks can be monitored through one or more personal devices 706 (e.g., personal fitness devices, personal fitness equipment connected to a network, etc.), the member 110 may be prompted to grant the representative 104 and the task coordination system 108 with access to these personal devices 706 in order to obtain data from these one or more personal devices 706. This data may be used to track the member's progress corresponding to one or more tasks of the proposal option/task grouping selected by the member 110.

In an embodiment, the representative 104 utilizes a task monitoring sub-system 704 of the task coordination system 108 to assist in the coordination and monitoring of performance of the project associated with the stated goal according to the parameters defined in the proposal option accepted by the member 110. The task monitoring sub-system 704 may be implemented using a computer system or as an application or other executable code implemented on a computer system of the task coordination system 108. As noted above, a member's performance of one or more tasks can be monitored through one or more personal devices 706 utilized by the member 110. The task monitoring sub-system 704 may access these one or more personal devices 706 to obtain data that may be used by the task monitoring sub-system 704 to determine the member's performance with regard to particular tasks from the task grouping, as well as the member's progress in achieving the stated goal. For instance, if a particular task requires the member 110 to perform interval training followed by running one mile, the task monitoring sub-system 704 may process data from the member's personal devices 706 to obtain biometric data (e.g., heart rate readings, blood pressure readings, PaO2 readings, etc.) as well as other data (e.g., number of steps taken, GPS data, etc.) that may be used to determine the member's cardiovascular performance and the member's movements over a period of time, which may be indicative of the member's performance of the interval training and run according to the task.

As noted above, each task associated with a particular task grouping may indicate a task duration, which may correspond to the expected time required for performance of the task. For example, a task to perform interval training followed by a one-mile run may specify, as a task duration, that it may take the member an hour to complete the task. This may allow the member to allocate this amount of time in a given day to perform the particular task. Further, a task may indicate a deadline for completion of the corresponding task. This may provide the member with flexibility to determine a best time to perform the stated task. The deadline for each task may be determined based on the parameters for completing the project according to a timeframe specified for achieving the goal. In an embodiment, the task monitoring sub-system 704 evaluates data obtained from the personal devices 706 associated with the member at the deadline corresponding to a task to determine whether the task has been performed. Using the illustrative example described above corresponding to member performance of interval training and running one mile, the task monitoring sub-system 704, at the deadline defined for the task, may evaluate the member's biometric data and other data from the member's personal devices 706 to determine whether the data is consistent with performance of the task (e.g., performing the required interval training and one mile run).

In some instances, in addition to processing data from the member's personal devices 706, the task monitoring sub-system 704 can prompt the member 110 to provide an update with regard to the task at the task deadline or at any other point prior to the deadline. For example, if the task monitoring sub-system 704 determines, based on the data from the member's personal devices 706 (or lack thereof), that the member 110 may not have completed the task, the task monitoring sub-system 704 can prompt the member 110 to indicate whether the task has been performed. The member 110 may perform manual entry 708 of data corresponding to performance of the task to the task monitoring sub-system 704 to indicate if the particular task has been completed. For instance, if the member is assigned with a task to complete a one mile run, the member 110 may provide information related to the run, such as the member's lap time for running one mile, the course taken by the member 110 to complete the one mile run, and the like. Further, the member 110 may provide feedback regarding its performance of the particular task. For instance, the member 110 may indicate whether performance of the task was onerous, difficult, or burdensome on the member 110. Alternatively, the member 110 may indicate whether it had a good experience in performing the task or is noticing improvements indicative of progress towards achievement of the goal.

In an embodiment, manual entry 708 of data corresponding to the performance of a task may be provided to the representative 104 by the member 110 via the communications session between the member 110 and the representative 104 established for the corresponding goal. For instance, at the deadline for a particular task, the representative 104 may communicate with the member 110 to determine whether the task has been completed and, if so, whether the member 110 had a positive experience in performing the task. The task monitoring sub-system 704, in an embodiment, can use NLP or other machine learning algorithm/artificial intelligence to process and evaluate these messages as they are being exchanged over the communications session. As an illustrative example, if a member 110 expresses in one or more messages to the representative 104 that it is unable to complete a particular task, the task monitoring sub-system 704, using NLP or other machine learning algorithm/artificial intelligence, may process these one or more messages in real-time, and as these messages exchanged, to determine that the particular task will not be completed by the deadline defined for the task. As another illustrative example, if a member expresses in one or more messages to the representative 104 that is has completed a particular task and that the member had fun or found the task to be invigorating, the task monitoring sub-system 704, using NLP or other machine learning algorithm/artificial intelligence, may determine that the particular task was completed and that the member 110 had a positive experience performing the task.

In an embodiment, if the task monitoring sub-system 704 determines that the current task of the task grouping associated with the project/stated goal has been completed, the task monitoring sub-system 704 may indicate, via the interface provided to the member 110 for the particular goal, that the task has been completed. Further, the task monitoring sub-system 704 may update the project corresponding to the stated goal to present the next task that is to be performed for achieving the stated goal. This next task may be presented as a new current task for the project. The task monitoring sub-system 704 may monitor performance of this new task according to the methods described above to determine whether the task has been completed successfully.

In an embodiment, if the task monitoring sub-system 704 determines that the current task has not been completed within the deadline defined for the task, the task monitoring sub-system 704 determines whether the project associated with the stated goal can be completed within the original timeframe defined for the project. For instance, the task monitoring sub-system 704 may automatically review the remaining tasks for the project corresponding to the stated goal to determine whether these tasks may be shifted or delayed to provide more time for completion of the current task without impacting the overall timeframe for completing the project. If the task monitoring sub-system 704 determines that the remaining tasks may be shifted or delayed to provide more time for completion of the current task, the task monitoring sub-system 704 may automatically, and dynamically, update the deadline for the current task to provide additional time for completion of the task. This may provide the member 110, representative 104, and/or third-party services or other services/entities associated with the task facilitation service performing the task more time to complete the task. Any other tasks associated with the project may also be shifted or delayed accordingly, if needed. For instance, the deadline for each of the other tasks may be adjusted to accommodate the additional time provided for completion of the current task.

In some instances, if the current task has not been completed within the deadline for completion of the current task, the task monitoring sub-system 704 may transmit a request to the task recommendation system to perform an evaluation as to whether the remaining tasks that are to be performed for the project associated with the stated goal may be adjusted to compensate for the inability to complete the current task. As noted above, the task recommendation system may automatically query the resource library 220 and/or one or more third-party resources to identify new tasks or modifications that may be made to the remaining set of tasks that may be performed within the remaining timeframe for the project. Based on its identification of new tasks or modifications to existing tasks for the project associated with the stated goal, the task recommendation system may provide these new tasks or modifications to the task monitoring sub-system 704. In turn, the task monitoring sub-system 704 can modify or replace the remaining set of tasks for the project to accommodate the newly identified tasks and/or modifications to the existing tasks, as identified by the task recommendation system. In some instances, if the task recommendation system identifies a new set of tasks for the stated goal, the task recommendation system may present this new set of tasks to the representative 104. The representative 104 may, in turn, generate a new proposal using the proposal creation sub-system 702. This new proposal may incorporate this new set of tasks as a proposal option for the project associated with the stated goal. The representative 104 may present this new proposal to the member 110 to allow the member 110 to determine whether to proceed with the new set of tasks.

As noted above, in addition to providing a proposal option corresponding to a new or modified set of tasks that may be completed in order to achieve the stated goal within the originally defined timeframe, the task recommendation system can provide one or more additional proposal options corresponding to alternative timeframes for achieving the stated goal. A new proposal option may include the current task and the remaining set of tasks, as originally proposed, with a new timeframe for completion of the current task and the remaining set of tasks. This new proposal option may specify a new timeframe that is adjusted from the original timeframe for the stated goal by an amount of time equal to the allotted time originally provided for the current task. This may allow the member 110, representative 104, and/or any third-party services or other services/entities associated with the task facilitation service an opportunity to perform the current task and all other subsequent tasks for the stated goal within the new timeframe.

In some instances, the new or modified set tasks and corresponding timeframes can be provided to the representative 104, which may use the new or modified set tasks and corresponding timeframes to generate possible proposal options, via the proposal creation sub-system 702, which may be presented to the member 110. In an embodiment, if the member 110 selects a new proposal option that includes a set of tasks performable by the member 110, representative 104, and/or one or more third-party services or other services/entities associated with the task facilitation service to achieve the stated goal, the task coordination system 108 can update the interface to replace the original set of tasks currently pending for the stated goal with the new or modified set of tasks corresponding to the new proposal option selected by the member 110. Further, the task coordination system 108 may provide the member 110 with the new timeframe for achieving the stated goal.

In an embodiment, if the task monitoring sub-system 704 determines that the current task has not been completed within the deadline defined for the task, the task monitoring sub-system 704 can determine whether the member 110 is to be offered with an alternative goal that may be achieved within the original timeframe defined for the project. For instance, the task monitoring sub-system 704 may transmit a request to the task recommendation system to perform an evaluation as to whether a new goal should be offered to the member 110 in light of the current task (or any number of tasks) not being completed within the deadline defined for the task. For instance, if the task recommendation system determines that the goal may no longer be achieved within the original timeframe as a result of the current task, or any number of previous tasks, not being completed according to the original timeframe and corresponding deadline(s), the task recommendation system may identify similar goals that may be achieved within the original timeframe. As an illustrative example, if the original goal was to run a marathon within the next twelve months, and the task recommendation system determines that this goal may no longer be achieved as a result of the member having missed one or more deadlines corresponding to tasks associated with training for the marathon, the task recommendation system may identify a new goal of running a half-marathon, for which training may be achieved within the original timeframe and based on the member's present progress with regard to the project.

In an embodiment, the task recommendation system can automatically identify a new goal and corresponding tasks that may be performed to accomplish the new goal within the original timeframe. For instance, the task recommendation system may use the original goal, performance metrics associated with previously performed or incomplete tasks (e.g., task completion rates, types of tasks completed, member-specific data (grades, measurements, progress reports, etc.), etc.) associated with the original goal, messages exchanged between the member 110 and the representative 104, information corresponding to the member 110, information from third-party resources, and historical data corresponding to goals and corresponding tasks performed by similarly-situated members as input to a machine learning algorithm or artificial intelligence to identify new goals that may be performed within the original timeframe and corresponding tasks that may be performed to achieve these new goals. For example, if the original goal is related to running a marathon within a particular timeframe, the task recommendation system may utilize the machine learning algorithm or artificial intelligence to identify other exercise goals that may be achieved within the particular timeframe.

In an embodiment, the task recommendation system can automatically identify a new goal in response to a member 110 indication that it is not going to be able to achieve the original goal within the originally defined timeframe. As noted above, the task monitoring sub-system 704 can use NLP or other machine learning algorithm/artificial intelligence to process and evaluate messages exchanged between the member 110 and the representative 104 in real-time as they are being exchanged over the communications session corresponding to the particular goal. The task monitoring sub-system 704 may determine, based on these exchanged messages, whether the member 110 has indicated that it would like to change the goal or otherwise that it is not likely going to achieve the goal within the original timeframe. If the task monitoring sub-system 704 detects, based on these messages, that the member 110 would like to change the goal or that the goal will not be achieved within the original timeframe, the task monitoring sub-system 704 may transmit a request to the task recommendation system to identify a new goal for the member 110 and corresponding tasks that may be performed within the original timeframe to achieve this new goal. The task recommendation system, accordingly, may generate different task groupings for the new goal, which may be presented to the member 110 in the form of proposal options, as described herein.

The task monitoring sub-system 704 may continue to monitor performance of the tasks associated with the stated goal to determine whether the stated goal has been achieved. For instance, as the member 110, representative 104, and/or any third-party services complete the tasks associated with the stated goal, the task monitoring sub-system 704 may record the progress towards achieving the stated goal. Additionally, the task monitoring sub-system 704 may monitor and process messages between the member 110 and the representative 104 in real-time and as these messages are exchanged to determine the progress towards achieving the stated goal. These messages may serve as feedback with regard to each performed task and to the overall structure of the set of tasks for achieving the stated goal. Further, once the set of tasks corresponding to the stated goal have been completed, the task monitoring sub-system 704 may transmit a request to the representative 104 or to the member 110 directly to prompt the member 110 for feedback with regard to the set of tasks and as to whether the stated goal was achieved as a result of performance of the set of tasks. If the member 110 indicates that the set of tasks helped the member 110 to achieve the stated goal, the monitoring sub-system 704 may assign a positive polarity to the set of tasks and the timeframe utilized for achieving the stated goal. Alternatively, if the member 110 indicates that the set of tasks were unfavorable and/or that performance of the set of tasks did not result in the member 110 achieving the stated goal, the monitoring sub-system 704 may assign a negative polarity to the set of tasks and timeframe utilized for achieving the stated goal. The obtained feedback, in an embodiment, can be used to update or retrain the machine learning algorithm or artificial intelligence utilized by the task recommendation system, as described above, to generate different groups of tasks that may be performed to achieve similar goals for similarly-situated members.

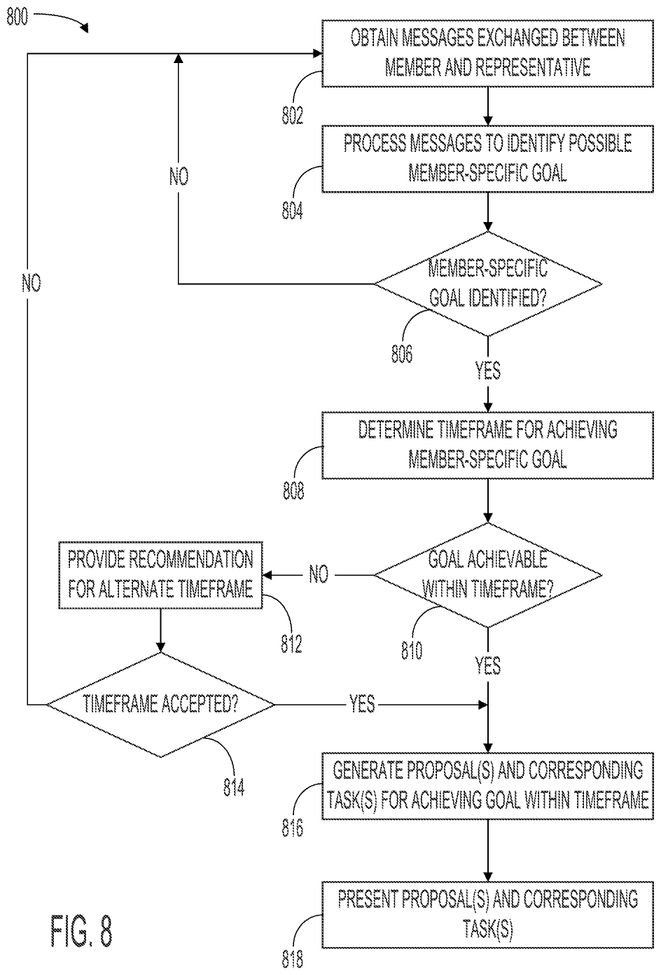

FIG. 8 shows an illustrative example of a process 800 for generating one or more proposals and corresponding tasks for achieving a member goal based on communications between a member and a representative in accordance with at least one embodiment. The process 800 may be performed by a task recommendation system and task coordination system of the task facilitation service. In some instances, certain steps of the process 800 (as described herein) may be performed by a representative, which may interact with the task recommendation system and/or the task coordination system to perform these steps.

At step 802, the task recommendation system may obtain messages exchanged between a member and an assigned representative. These messages may be obtained in real-time as they are exchanged between the member and the assigned representative. For instance, the task recommendation system may maintain an active feed or data stream through which messages exchanged between the member and the assigned representative are provided automatically, and in real-time, to the task recommendation system.

At step 804, the task recommendation system may process these messages in real-time to identify possible member-specific goals. For instance, the task recommendation system may process messages between the member and the representative as these messages are being exchanged using a machine learning algorithm or artificial intelligence to automatically identify any member goals for which the representative and the task facilitation service may provide assistance to the member for achieving these goals. The task recommendation system may utilize NLP or other artificial intelligence to evaluate these exchanged messages or other communications from the member to identify any goals that the member would like to achieve. In some instances, the task recommendation system may utilize historical data corresponding to previously identified goals for similarly-situated members and corresponding messages from these members to train the NLP or other artificial intelligence to identify possible goals.

At step 806, based on this processing and evaluation of the messages between the member and the representative, the task recommendation system may determine whether any member-specific goals have been identified. If the task recommendation system has not identified any new member-specific goals based on its processing and evaluation of the obtained messages, the task recommendation system may continue to obtain messages between the member and the representative as these messages are exchanged in real-time and evaluate these messages accordingly, thereby restarting the process 800.

If the task recommendation system identifies a member-specific goal based on its evaluation of the messages exchanged between the member and the representative, the task recommendation system, at step 808, may determine a timeframe for achieving the member-specific goal. For instance, from the messages exchanged between the member and the representative, the task recommendation system may utilize NLP or other artificial intelligence to evaluate these exchanged messages or other communications from the member to the representative to identify a specified timeframe for achieving the goal. As an illustrative example, if the member transmits the message, “I really want to be able to run a marathon next year,” the task recommendation system may determine, using NLP or other artificial intelligence, that the timeframe for the goal “run a marathon” is some point in the “next year.” In an embodiment, if the member has not expressed a timeframe for achieving the goal, the task recommendation system may prompt the representative to communicate with the member to determine a timeframe for achieving the goal.

At step 810, the task recommendation system may determine whether the member-specific goal may be achieved within the identified timeframe. For instance, the task recommendation system may use member profile associated with the member, corresponding tasks, and member-representative conversations as input to a machine learning algorithm or artificial intelligence to generate a cognitive load score for the member. The task recommendation system can use the cognitive load score for the member to determine whether the timeframe for achieving the goal as provided by the member is feasible. For instance, the task recommendation system may determine, based on the cognitive load score for the member, that the timeframe for achieving the goal (as specified by the member) may lead to an increase in the cognitive load of the member (e.g., high levels of stress may result from trying to achieve the goal and other pertinent tasks within the timeframe). If this cognitive load score exceeds a maximum cognitive load threshold value, the task recommendation system may determine that the timeframe for achieving the goal may be too onerous on the member and the task recommendation system, at step 812, may identify an alternative timeframe that may be proposed to the member and that may reduce the member's cognitive load.

If the task recommendation system determines that an alternative timeframe for achievement of the goal should be proposed to the member, the task recommendation system may transmit a notification to the representative to provide any information related to the alternative timeframe for achieving the goal. The representative may propose this alternative timeframe to the member via the communications session. If the member opts to accept the proposed alternative timeframe, the representative may indicate, to the task recommendation system, that the member has accepted the alternative timeframe for achieving the goal. Alternatively, if the member opts to reject the proposed alternative timeframe, the representative may work with the member to determine whether to abandon the stated goal and/or identify alternative goals that may be achievable within the original timeframe proposed by the member. This may result in the process 800 being restarted, whereby the task recommendation system may process new messages as they are being exchanged to identify new goals for the member.

If the new timeframe is accepted, or the goal is achievable within the original timeframe defined by the member, the task recommendation system may indicate that the representative may proceed to generate a proposal for the achieving the goal within the defined timeframe. Accordingly, the representative may define a new project corresponding to the member's stated goal, for which a set of tasks may be added to the project. This set of tasks may be performed by the member, representative, and/or third-party services or other services/entities associated with the task facilitation service to achieve the stated goal. In an embodiment, the task recommendation system, in conjunction with a task coordination system, can generate a set of proposal options and corresponding task groupings (e.g., sets of tasks corresponding to different methods for achieving the goal) that may be presented to the member at step 816. As noted above, the task recommendation system may use information corresponding to the goal, information corresponding to the member, and historical data corresponding to goals and corresponding tasks performed by similarly-situated members as input to a machine learning algorithm or artificial intelligence to identify tasks that may be performed to achieve the member's goal. Based on characteristics of the new goal (e.g., category of the goal, timeframe for achieving the goal, etc.), characteristics of the member, and data corresponding to these similarly-situated members, the task recommendation system may automatically generate a set of tasks that may be performed within the stated timeframe to achieve the new goal.

As noted above, to generate the different task groupings that may be presented as different proposal options for achieving the stated goal, the task recommendation system can query the resource library and/or one or more third-party resources to identify possible tasks that may be added to the project for achieving the stated goal. From the resource library and/or one or more third-party resources, the task recommendation system may identify known regimens, learning plans, classes, and the like that may be implemented in order to achieve the stated goal. The task recommendation system may automatically process this information from the resource library and/or one or more third-party resources to generate individual tasks that may be performed by the member, representative, and/or third-party services to achieve the stated goal within the desired timeframe. Each task may serve as an increment of the identified regimen, whereby the progress towards achieving the stated goal may be evaluated at the end of a given deadline for completion of the task. Further, from the resource library and/or one or more third-party resources, the task recommendation system can identify different methods that may be performed to achieve the goal. From each available method, the task recommendation system can create a task grouping that may be proposed to the member in the form of a proposal option.

In some instances, the task recommendation system allows the representative to manually generate one or more tasks for the project associated with the stated goal. For instance, if the representative has knowledge regarding the particular goal that is to be achieved, the representative can manually define one or more regimens or other methods for achieving this goal. Each regimen or other method may include a task grouping that may be performed by the member, representative, and/or third-party services or other services/entities associated with the task facilitation service in order to achieve the stated goal. The representative may indicate a completion date for each task in accordance with the overall timeframe for achieving the goal. The task recommendation system can further provide the representative with access to the resource library and any known third-party resources to allow the representative to query the resource library and these third-party resources to identify possible tasks that may be added to the new project for achieving the stated goal. Based on the representative's review of the resource library and these third-party resources, the representative may manually generate a set of tasks corresponding to any training plans or other information provided by these third-party resources for achieving the stated goal.

In an embodiment, to generate the proposal and corresponding proposal options, the task recommendation system can provide the representative with a ranking or other ordering of the different task groupings generated for the particular project associated with the stated goal. This ranking may be generated based on the likelihood of the member selecting a particular grouping of tasks (e.g., a particular method or plan) for accomplishing the stated goal. From this ranked list of task groupings, the task recommendation system may select which task groupings may be recommended to the member by the representative. The representative can review the provided listing of the task groupings provided by the task recommendation system and select one or more task groupings that may be used to create one or more proposal options to be included in a proposal to the member for completion of the project associated with the goal. As noted above, the representative, via the task coordination system, can generate a proposal for achieving the stated goal, whereby the proposal may provide, amongst other things, a list of proposal options corresponding to the different methods (e.g., task groupings) that may be performed to achieve the stated goal.

At step 818, the representative may present a proposal including one or more proposal options and corresponding task groupings to the member. The proposal may include the one or more proposal options, wherein a proposal option may include a grouping of tasks that may be performed to achieve the stated goal within a given timeframe. Based on the member responses to the various options presented in the proposal, the representative may present tasks associated with a selected option via a project interface, through which the member may review the project corresponding to the stated goal and the tasks corresponding to the selected proposal option for the particular project.

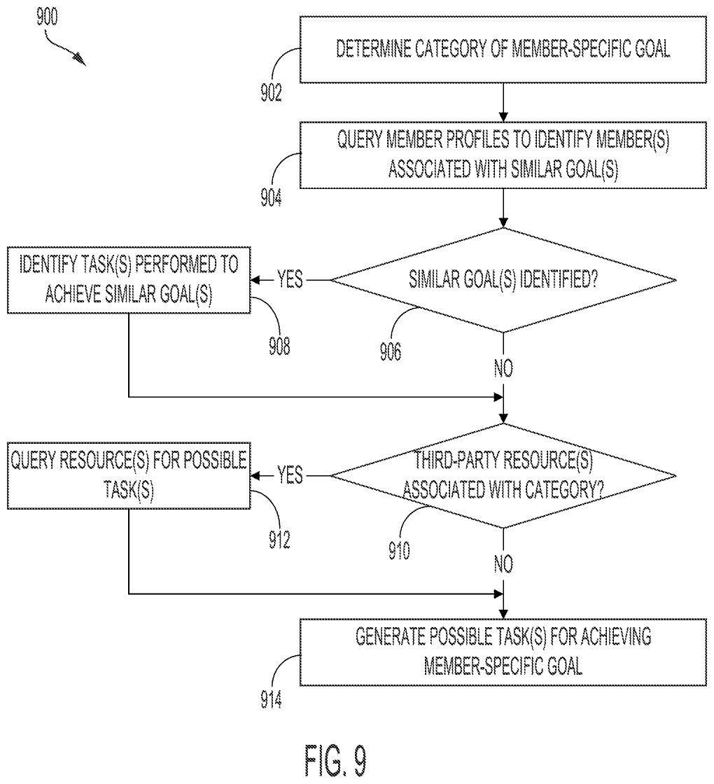

FIG. 9 shows an illustrative example of a process 900 for training and using a machine learning algorithm, artificial intelligence, or other form of executable process to generate possible tasks for achieving a member goal in accordance with at least one embodiment. The process 900 may be performed by a task recommendation system, which may use a machine learning algorithm, artificial intelligence, or other form of executable process to automatically and dynamically generate different task groupings that may be used to achieve a particular goal defined by a member of the task facilitation service.

At step 902, the task recommendation system may determine the category or type of the member-specific goal. For instance, the task recommendation system may use information corresponding to the member-specific goal as input to a machine learning algorithm, artificial intelligence, or other form of executable process to determine the particular category or type for the member-specific goal. This information may include a name or title for the goal, a short description of the goal, any messages exchanged between the member and the representative that are indicative of the goal, and the like. The machine learning algorithm or artificial intelligence can include a clustering algorithm that is configured to identify a particular cluster of similar goals that may correspond to a particular category of goals. This clustering algorithm may be trained using unsupervised learning techniques. For instance, a dataset of input goal characteristics corresponding to identified goals may be analyzed using the clustering algorithm to identify different goal categories. Example clustering algorithms that may trained using sample goal datasets (e.g., historical goal data, hypothetical goal data, etc.) to classify a goal in order to identify a category for the goal may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm generated using the obtained information related to the goal, the task recommendation system may determine a category for the goal.

In some instances, rather than using a machine learning algorithm or artificial intelligence, the task recommendation system may automatically, and in real-time, determine the category or type of the member-specific goal. For instance, the task recommendation system may automatically, and in real-time, submit a query to the resource library to identify a particular category or type for the goal. The query may include one or more keywords corresponding to the goal. For example, the one or more keywords may correspond to the name or title assigned to the goal. As another example, the one or more keywords may be automatically selected based on the short description or messages exchanged between the member and the representative about the particular goal. The task recommendation system, in some instances, may automatically, and in real-time, process these data sources associated with the goal (e.g., the title, description, and corresponding messages) to identify one or more anchor terms that may serve as the terms to be used for the query to the resource library. In response to the query, the resource library may return an indication of the category or type associated with the particular goal. This indication may include a project generation template corresponding to the particular category or type associated with the particular goal. Alternatively, the indication may include previously generated projects corresponding to other goals associated with other members of the task facilitation service. These other goals may correspond to the same goal category or type, enabling the task recommendation system to automatically discern the goal category or type for the particular goal.

At step 904, the task recommendation system may query member profiles from the user datastore to identify one or more similarly-situated members associated with similar goals. For example, the task recommendation system may implement a clustering algorithm to identify similarly-situated members based on one or more vectors of similarity (e.g., geographic location, demographic information, goals within the same category of the member-specific goal, previously performed tasks and task categories/types, family composition, home composition, etc.). In some instances, a dataset of input member characteristics corresponding to goals provided by sample members may be analyzed using a clustering algorithm to identify different types of members. Based on the output of the machine learning algorithm generated using the member's characteristics and the category for the goal (as determined in step 902), the clustering algorithm may identify a particular cluster for the member. This cluster may include a grouping of similarly-situated members that may be evaluated to identify possible tasks for achieving the member's goal.

In some instances, rather than using a clustering algorithm to identify one or more similarly-situated members associated with similar goals, the task recommendation system can automatically, and in real-time, query a user datastore maintained by the task facilitation service to identify any other members that either have previously achieved similar goals or that are in the process of achieving similar goals. For instance, the task recommendation system may use the identified category or type associated with the particular goal to query the user datastore. In response to this query, the user datastore may identify a set of other members for which goals corresponding to the category or type have been achieved or are in the process of being achieved. The task recommendation system may use the response to the query to evaluate the member profiles corresponding to these members to review these similar goals.

At step 906, the task recommendation system may determine whether one or more similar goals have been identified from the evaluation of the member profiles corresponding to the similarly-situated members identified above. For instance, the task recommendation system may access the member profiles of the identified similarly-situated members to determine whether any of these similarly-situated members have stated goals similar to the member-specific goal specified by the member. To identify these similar goals, the task recommendation system may evaluate the goals associated with each similarly-situated member to determine whether any of these goals belong to the same goal category of the member-specific goal. If no identified goal from these similarly-situated members belongs to the same category as that of the member-specific goal, the task recommendation system may determine that no similar goals were identified.

If the task recommendation system identifies one or more similar goals from these similarly-situated members, the task recommendation system, at step 908, may identify the one or more tasks performed for each of these similar goals in order to achieve these goals. As noted above, a member profile may include a historical record of previously performed tasks and projects. For each previously performed project, the task recommendation system may determine whether the project corresponds to a similar goal. If so, the task recommendation system may review this previously performed project to identify the myriad tasks performed by the similarly-situated member, their representative, and/or any third party services or other services/entities associated with the task facilitation service to achieve the corresponding goal.

In an embodiment, if the task recommendation system identifies different task groupings for similar goals from the similarly-situated members, or as a result of no similar goals being identified, the task recommendation system, at step 910, can determine whether there are any third-party resources associated with the goal category of the member-specific goal. As noted above, the task facilitation service may partner with various organizations (e.g., publishers, clubs, affinity groups, etc.) that may provide or otherwise aggregate information related to different hobbies and intents that may be associated with different goal categories and types. Thus, based on the particular category of the member-specific goal, the task recommendation system may determine, from these one or more third-party resources, whether any of these third-party resources correspond to the category of the member-specific goal.

In some instances, to determine whether there are any third-party resources associated with the goal category, the task recommendation system may submit a query to the resource library to identify any available third-party resources for the particular goal. As noted above, the resource library may serve as a repository for various third-party resources that may be used to generate new projects and/or tasks that may be performed for the benefit of members of the task facilitation service. Additionally, the resource library may store information corresponding to different tasks that may have been previously performed for different goals or goal types/categories. The resource library may be updated by representatives and third-party entities based on their knowledge of tasks that may be performed in order to achieve corresponding goals. Thus, from the resource library, the task recommendation system may automatically identify any third-party resources previously utilized to generate tasks for similarly-situated members and/or for similar goals

If the task recommendation system identifies one or more third-party resources associated with the category of the member-specific goal, the task recommendation system, at step 912, can query these third-party resources to identify possible tasks that may be performed to achieve the goal. For instance, from these one or more third-party resources, the task recommendation system may identify known regimens, learning plans, classes, and the like that may be implemented in order to achieve the stated goal. These known regimens, learning plans, classes, and the like may be processed by the task recommendation system to identify possible tasks that may be performed to achieve the stated member-specific goal.

At step 914, the task recommendation system may generate possible tasks and corresponding task groupings for achieving the member-specific goal. For instance, the task recommendation system may use information corresponding to the member-specific goal, information corresponding to the member, any historical data corresponding to goals and corresponding tasks performed by similarly-situated members, and any information from identified third-party resources as input to a machine learning algorithm or artificial intelligence to identify tasks that may be performed to achieve the member's new goal. As noted above, the machine learning algorithm or artificial intelligence utilized by the task recommendation system to automatically, and dynamically, generate a set of tasks for accomplishing an identified goal may be trained using supervised training techniques, as described above. Further, the machine learning algorithm or artificial intelligence can be evaluated to determine, based on the sample inputs supplied to the machine learning algorithm or artificial intelligence, whether the machine learning algorithm or artificial intelligence is producing sets of tasks that are conducive to achieving a corresponding goal within a predefined timeframe. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from members and representatives with regard to the tasks provided by the machine learning algorithm or artificial intelligence for given goals.

In some instances, the task recommendation system, rather than using a machine learning algorithm or artificial intelligence to generate these possible tasks, may provide the information from the identified third-party resources to the representative assigned to the member. This may allow the representative to manually generate a set of possible tasks that may be performed to achieve the member-specific goal. In an embodiment, the task recommendation system can automatically, and in real-time, identify one or more tasks for achieving the member-specific goal based on historical data corresponding to goals and corresponding tasks performed by similarly-situated members. For example, if the task recommendation system identifies a previously achieved goal for another member of the task facilitation that is similar to the member-specific goal for which possible tasks are being identified, the task recommendation system may automatically identify the tasks performed to achieve the previously achieved goal. These tasks may be modified to conform with the member-specific goal according to characteristics of the member (as indicated in the member profile associated with the member).

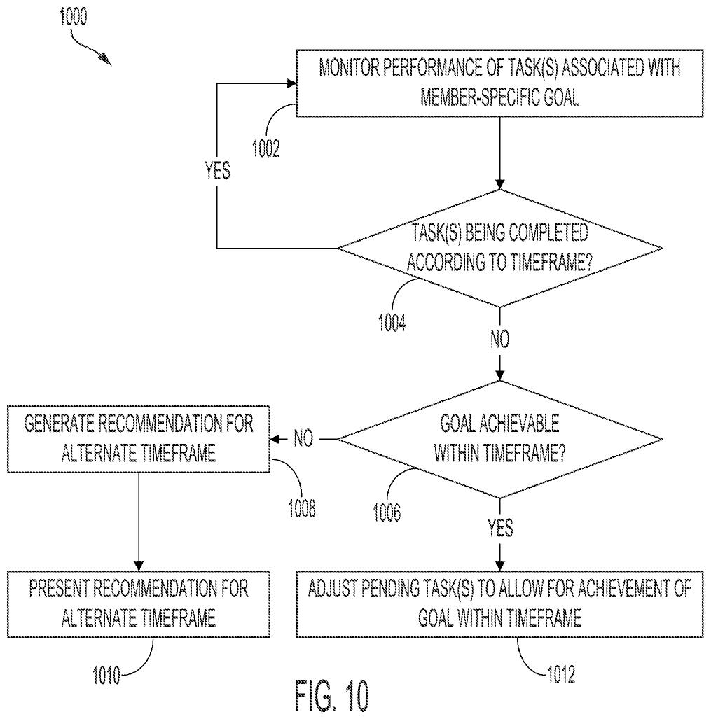

FIG. 10 shows an illustrative example of a process 1000 for monitoring member performance of tasks associated with a member goal and automatically adjusting a timeframe and/or tasks associated with the member goal upon detection of deviations from an original timeframe for achieving the member goal in accordance with at least one embodiment. The process 1000 may be performed by a task coordination system of the task facilitation service. In some instances, particular steps of the process 1000 may be performed in conjunction with a task recommendation system of the task facilitation service, as described herein.

At step 1002, the task coordination system may monitor, in real-time, performance of the one or more tasks associated with a member-specific goal. As described above, if one or more tasks are to be performed by the member, the task coordination system may monitor performance of these task through one or more personal devices utilized by the member. The task coordination system may obtain data from these devices that may be used to determine the member's performance with regard to particular tasks, as well as the member's progress in achieving the stated goal. In some instances, the task coordination system may further prompt the member, representative, and/or third-party services or other services/entities associated with the task facilitation service assigned to perform these tasks to provide an update with regard to the performance of these tasks.

At step 1004, the task coordination system may determine whether the current tasks for the member-specific goal are being according to the timeframe defined for achieving the goal. For instance, the task coordination system may process data from the member's personal devices, as well as any updates provided by the member, representative, and/or third-party services or other services/entities associated with the task facilitation service assigned to perform these tasks to determine whether these tasks are being completed according to the deadlines established for performance of these tasks. For example, if the task coordination system determines, based on the data from the member's personal devices (or lack thereof), that the member may not have completed the task, the task coordination system can prompt the member to indicate whether the task has been performed. In some instances, at the deadline for a particular task, the representative may communicate with the member to determine whether the task has been completed. The task coordination system may use NLP or other machine learning algorithm/artificial intelligence to process and evaluate these messages as they are being exchanged over the communications session associated with the goal to determine whether the task has been completed. If tasks are being completed according to the deadlines and timeframe for achieving the goal, the task coordination system may continue to monitor performance of the remaining tasks associated with the goal, thereby beginning the process 1000 anew.

If the task coordination system determines that one or more tasks have not been completed according to their corresponding deadlines and the timeframe defined for the goal, the task coordination system, at step 1006, may determine whether the member-specific goal is achievable within the original timeframe defined for the goal. For instance, the task coordination system may automatically review the remaining tasks for the project associated with the stated goal to determine whether these tasks may be time-shifted or delayed to provide more time for completion of the current task without impacting the overall timeframe for completing the project. If the task coordination system determines that the remaining tasks may be time-shifted or delayed to provide more time for completion of the current task, the task coordination system, at step 1012, may automatically, and dynamically, adjust the pending tasks associated with the goal to allow for achievement of the goal within the original timeframe. For instance, the task coordination system may update the deadline for the current task to provide additional time for completion of the task. Further, any other tasks associated with the project may also be time-shifted or delayed accordingly, if needed. For instance, the deadline for each of the other tasks may be adjusted to accommodate the additional time provided for completion of the current task.

In some examples, the task coordination system may transmit a request to the task recommendation system to perform an evaluation as to whether the remaining tasks that are to be performed for the project associated with the stated goal may be adjusted to compensate for the inability to complete the current task. As noted above, the task recommendation system may automatically query the resource library and/or one or more third-party resources to identify new tasks or modifications that may be made to the remaining set of tasks that may be performed within the remaining timeframe for the project. Based on its identification of new tasks or modifications to existing tasks for the project associated with the stated goal, the task recommendations system may provide these new tasks or modifications to the task coordination system. In turn, the task coordination system can modify or replace the remaining set of tasks for the project to accommodate the newly identified tasks and/or modifications to the existing tasks, as identified by the task recommendation system. In some instances, if the task recommendation system identifies a new set of tasks for the stated goal, the task recommendation system may present this new set of tasks to the representative. The representative may, in turn, generate a new proposal that incorporates this new set of tasks as a proposal option for the project associated with the stated goal. The representative may present this new proposal to the member to allow the member to determine whether to proceed with the new set of tasks.

If the task coordination system determines that the goal is no longer achievable within the original timeframe, the task coordination system, at step 1008, may generate a recommendation for an alternative timeframe for achievement of the goal. For instance, the task coordination system may generate a proposal option corresponding to an alternative timeframe for achieving the stated goal. A new proposal option may include the current task and the remaining set of tasks, as originally proposed, with a new timeframe for completion of the current task and the remaining set of tasks. This new proposal option may specify a new timeframe that is adjusted from the original timeframe for the stated goal by an amount of time equal to the allotted time originally provided for the current task. This may allow the member, representative, and/or any third-party services an opportunity to perform the current task and all other subsequent tasks for the stated goal within the new timeframe.

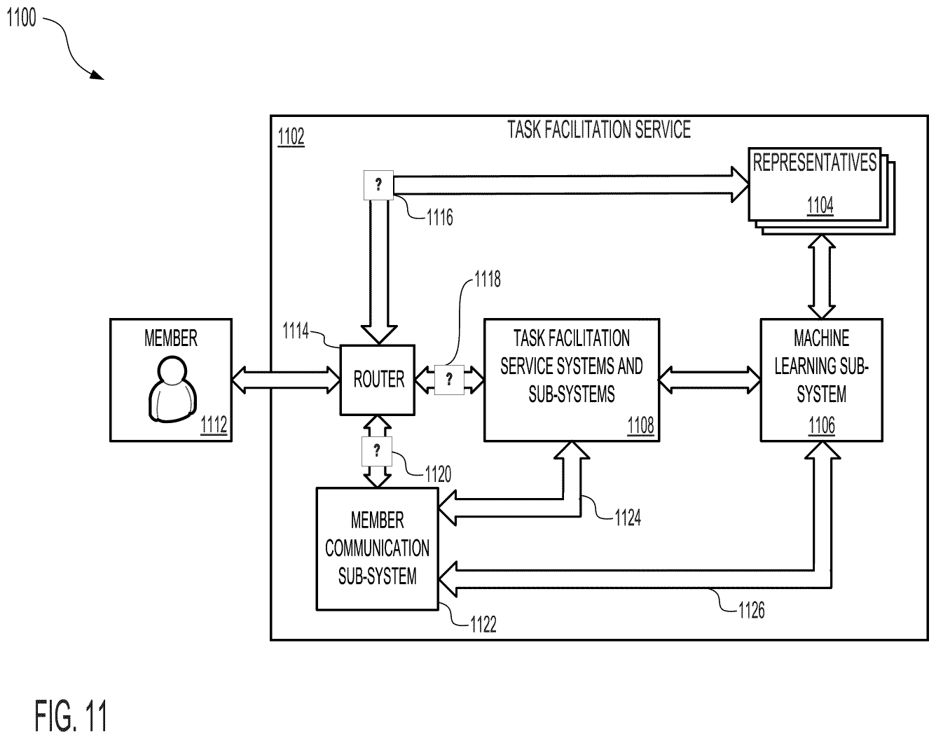

FIG. 11 shows an illustrative example of an environment 1100 in which communications with members are processed in accordance with at least one embodiment. In an embodiment, operations performed by representatives 1104 are partially and/or fully performed using one or more machine learning algorithms, artificial intelligence systems and/or computational models. For example, as the representatives 1104 perform or otherwise coordinate performance of tasks on behalf of a member 1112, the task facilitation service 1102 may update a profile of the member 1112 and/or a computational model of the profile of the member 1112.

In an embodiment, as the representatives 1104 perform or otherwise coordinate performance of tasks on behalf of a member 1112, the task facilitation service 1102 updates a profile of the member 1112 and/or a computational model of the profile of the member 1112 continuously. For example, as a member 1112 communicates with a system of the task facilitation service 1102, the task facilitation service 1102 may update the profile of the member 1112 and/or a computational model of the profile of the member 1112 continuously during the course of the interaction.

In an embodiment, as the representatives 1104 perform or otherwise coordinate performance of tasks on behalf of a member 1112, the task facilitation service 1102 updates a profile of the member 1112 and/or a computational model of the profile of the member 1112 dynamically. For example, as a task is performed on behalf of a member 1112, a vendor performing the task may provide regular updates to the task facilitation service 1102 and the task facilitation service 1102 may update the profile of the member 1112 and/or a computational model of the profile of the member 1112 dynamically at each update from the vendor.

In an embodiment, as the representatives 1104 perform or otherwise coordinate performance of tasks on behalf of a member 1112, the task facilitation service 1102 updates a profile of the member 1112 and/or a computational model of the profile of the member 1112 automatically. For example, when a proposal is generated for the member, the task facilitation service 1102 may update the profile of the member 1112 and/or a computational model of the profile of the member 1112 automatically as part of the proposal generation process.

In an embodiment, as the representatives 1104 perform or otherwise coordinate performance of tasks on behalf of a member 1112, the task facilitation service 1102 updates a profile of the member 1112 and/or a computational model of the profile of the member 1112 in real-time. For example, when a member 1112 accepts a proposal, the task facilitation service 1102 may update the profile of the member 1112 and/or a computational model of the profile of the member 1112 at the time that the proposal acceptance is provided, rather than delaying the update.

In an embodiment, the task facilitation service 1102 updates a profile of the member 1112 and/or a computational model of the profile of the member 1112 using a machine learning sub-system 1106 of the task facilitation service 1102. In an embodiment, a machine learning sub-system 1106 is a component of the task facilitation service 1102 that is configured to implement machine learning algorithms, artificial intelligence systems, and/or computation models. In an example, a machine learning sub-system 1106 may use various algorithms to train a machine learning model using sample and/or live data. Additionally, a machine learning sub-system 1106 may update the machine learning model as new data is received. In another example, the machine learning sub-system 1106 may train and/or update various artificial intelligence systems or generate, train and/or update various computational models. For example, a computational model of the profile of the member 1112 may be generated, trained and/or updated by the machine learning sub-system 1106 as new information is received about the member 1112.

In an embodiment, after the profile of the member 1112 and/or a computational model of the profile of the member 1112 has been updated over a period of time (e.g., six months, a year, etc.) and/or over a set of tasks (e.g., twenty tasks, thirty tasks, etc.), systems of the task facilitation service 1102 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1102 (e.g., a task recommendation system) can automatically communicate with the member 1112 to obtain any additional information needed and can also generate proposals that may be presented to the member 1112 for performance of these tasks.

In the example illustrated in FIG. 11, communications between the member 1112 and the task facilitation service 1102 may be routed to one or more entities within the task facilitation service 1102. The example illustrated in FIG. 11 shows a communication router 1114 (referred to in the illustration as a “router”) however, as may be contemplated and as illustrated in FIG. 11, the router 1114 is an abstract representation of one or more techniques for routing communications between entities. Accordingly, communications from the member 1112 to the task facilitation service 1102 may be routed to one or more entities of the task facilitation service and communications from the one or more entities of the task facilitation service 1102 may be routed back to the member 1112.

In the example illustrated in FIG. 11, the representatives 1104 can monitor communications between task facilitation service systems and/or sub-systems 1108 and the member 1112 to ensure that the interaction maintains a positive polarity as described herein because the communications can be routed 1116 to the representatives 1104 and also routed 1118 to task facilitation service systems and/or sub-systems 1108. For example, if a member 1112 is interacting with the task recommendation system, the representatives 1104 can determine whether the member 1112 is satisfied with the interaction. If the representatives 1104 determine that the conversation has a negative polarity (e.g., that the member 1112 is not satisfied with the interaction), the representatives 1104 may intervene to improve the interaction.

Similarly, other interactions between task facilitation service systems and/or sub-systems 1108 and the member 1112 may be routed 1120 to a member communication sub-system 1122 which may be configured to monitor the interactions between task facilitation service systems and/or sub-systems 1108 and the member 1112. In an embodiment, the member communication sub-system 1122 can be configured to intercept the interactions between task facilitation service systems and/or sub-systems 1108 and the member 1112 (using, for example, the router 1114). In such an embodiment, all such interactions can be routed 1120 between the member 1112 and the member communication sub-system 1122 and can be routed 1124 between the member communication sub-system 1122 and the task facilitation service systems and/or sub-systems 1108. In such an embodiment, interactions between the task facilitation service systems and/or sub-systems 1108 and the member 1112 may not be routed 1118 directly. In such an embodiment, the representatives 1104 may still monitor interactions between task facilitation service systems and/or sub-systems 1108 and the member 1112 to ensure that the interaction maintains a positive polarity as described above (e.g., by routing 1116 the interactions to the representatives 1104).

In an embodiment, the representatives 1104 can interact with the machine learning sub-system 1106 to update the profile of the member indicating changing member preferences based on an interaction between the representatives 1104 the member 1112. In an embodiment, the task facilitation service systems and/or sub-systems 1108 can interact with the machine learning sub-system 1106 to update the profile of the member when, for example, a proposal is accepted or rejected. Additionally, as illustrated in FIG. 11, the interactions between the task facilitation service 1102 and the member 1112 can be additionally routed 1126 between the member communication sub-system 1122 and the machine learning sub-system 1106. Accordingly, interactions between the member 1112 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1108 can update the profile of the member 1112 and/or a computational model of the profile of the member 1112 continuously, dynamically, automatically, and/or in real-time. For example, task facilitation service systems and/or sub-systems 1108 can update the profile of the member 1112 and/or a computational model of the profile of the member 1112 using the machine learning sub-system 1106 as described herein. Accordingly, task facilitation service systems and/or sub-systems 1108 can update the profile of the member 1112 and/or a computational model of the profile of the member 1112 to provide up-to-date information about the member based on the member's automatic interaction with the task facilitation service 1102, based on the member's interaction with the representative 1104, and/or based on tasks performed on behalf of the member 1112 over time. This information may also be updated continuously, automatically, dynamically, and/or in real-time as tasks and/or proposals are created, proposed, and performed for the member 1112. This information may also be used by the task facilitation service 1102 to anticipate, identify, and present appropriate or intelligent interactions with the member 1112 (e.g., in response to member 1112 queries, needs, and/or goals).

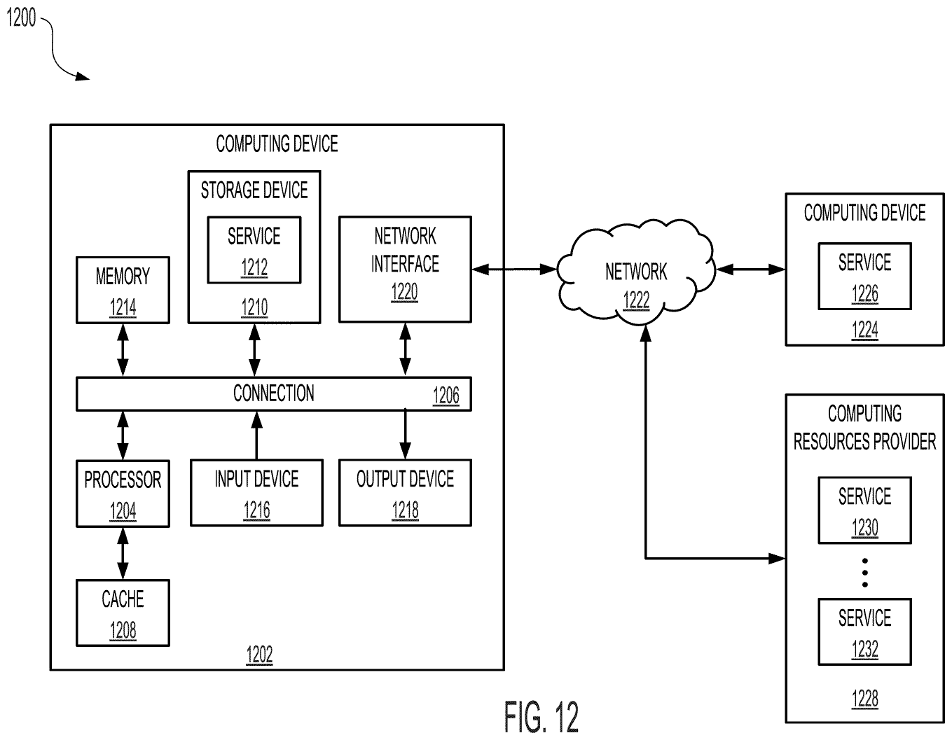

FIG. 12 illustrates a computing system architecture 1200, including various components in electrical communication with each other, in accordance with some embodiments. The example computing system architecture 1200 illustrated in FIG. 12 includes a computing device 1202, which has various components in electrical communication with each other using a connection 1206, such as a bus, in accordance with some implementations. The example computing system architecture 1200 includes a processing unit 1204 that is in electrical communication with various system components, using the connection 1206, and including the system memory 1214. In some embodiments, the system memory 1214 includes read-only memory (ROM), random-access memory (RAM), and other such memory technologies including, but not limited to, those described herein. In some embodiments, the example computing system architecture 1200 includes a cache 1208 of high-speed memory connected directly with, in close proximity to, or integrated as part of the processor 1204. The system architecture 1200 can copy data from the memory 1214 and/or the storage device 1210 to the cache 1208 for quick access by the processor 1204. In this way, the cache 1208 can provide a performance boost that decreases or eliminates processor delays in the processor 1204 due to waiting for data. Using modules, methods and services such as those described herein, the processor 1204 can be configured to perform various actions. In some embodiments, the cache 1208 may include multiple types of cache including, for example, level one (L1) and level two (L2) cache. The memory 1214 may be referred to herein as system memory or computer system memory. The memory 1214 may include, at various times, elements of an operating system, one or more applications, data associated with the operating system or the one or more applications, or other such data associated with the computing device 1202.

Other system memory 1214 can be available for use as well. The memory 1214 can include multiple different types of memory with different performance characteristics. The processor 1204 can include any general purpose processor and one or more hardware or software services, such as service 1212 stored in storage device 1210, configured to control the processor 1204 as well as a special-purpose processor where software instructions are incorporated into the actual processor design. The processor 1204 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1204 can be a microprocessor, a microcontroller, a digital signal processor (“DSP”), or a combination of these and/or other types of processors. In some embodiments, the processor 1204 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1200, an input device 1216 can represent any number of input mechanisms, such as a microphone for speech, a touch-sensitive screen for gesture or graphical input, keyboard, mouse, motion input, pen, and other such input devices. An output device 1218 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1200. In some embodiments, the input device 1216 and/or the output device 1218 can be coupled to the computing device 1202 using a remote connection device such as, for example, a communication interface such as the network interface 1220 described herein. In such embodiments, the communication interface can govern and manage the input and output received from the attached input device 1216 and/or output device 1218. As may be contemplated, there is no restriction on operating on any particular hardware arrangement and accordingly the basic features here may easily be substituted for other hardware, software, or firmware arrangements as they are developed.

In some embodiments, the storage device 1210 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1210 can include hardware and/or software services such as service 1212 that can control or configure the processor 1204 to perform one or more functions including, but not limited to, the methods, processes, functions, systems, and services described herein in various embodiments. In some embodiments, the hardware or software services can be implemented as modules. As illustrated in example computing system architecture 1200, the storage device 1210 can be connected to other parts of the computing device 1202 using the system connection 1206. In an embodiment, a hardware service or hardware module such as service 1212, that performs a function can include a software component stored in a non-transitory computer-readable medium that, in connection with the necessary hardware components, such as the processor 1204, connection 1206, cache 1208, storage device 1210, memory 1214, input device 1216, output device 1218, and so forth, can carry out the functions such as those described herein.

The disclosed processed for generating and executing experience recommendations can be performed using a computing system such as the example computing system illustrated in FIG. 12, using one or more components of the example computing system architecture 1200. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1204 wherein the code is stored in memory such as memory 1214 as described herein. One or more of a user device, a provider server or system, a database system, or other such devices, services, or systems may include some or all of the components of the computing system such as the example computing system illustrated in FIG. 12, using one or more components of the example computing system architecture 1200 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1228. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1204 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1214 can be coupled to the processor 1204 by, for example, a connector such as connector 1206, or a bus. As used herein, a connector or bus such as connector 1206 is a communications system that transfers data between components within the computing device 1202 and may, in some embodiments, be used to transfer data between computing devices. The connector 1206 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1214 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1214 can also include magnetic or optical data storage media including read-only (e.g., CD ROM and DVD ROM) or otherwise (e.g., CD or DVD). The memory can be local, remote, or distributed.

As described above, the connector 1206 (or bus) can also couple the processor 1204 to the storage device 1210, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1210. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1206 can also couple the processor 1204 to a network interface device such as the network interface 1220. The interface can include one or more of a modem or other such network interfaces including, but not limited to those described herein. It will be appreciated that the network interface 1220 may be considered to be part of the computing device 1202 or may be separate from the computing device 1202. The network interface 1220 can include one or more of an analog modem, Integrated Services Digital Network (ISDN) modem, cable modem, token ring interface, satellite transmission interface, or other interfaces for coupling a computer system to other computer systems. In some embodiments, the network interface 1220 can include one or more input and/or output (I/O) devices. The I/O devices can include, by way of example but not limitation, input devices such as input device 1216 and/or output devices such as output device 1218. For example, the network interface 1220 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1202 can be connected to one or more additional computing devices such as computing device 1224 via a network 1222 using a connection such as the network interface 1220. In such embodiments, the computing device 1224 may execute one or more services 1226 to perform one or more functions under the control of, or on behalf of, programs and/or services operating on computing device 1202. In some embodiments, a computing device such as computing device 1224 may include one or more of the types of components as described in connection with computing device 1202 including, but not limited to, a processor such as processor 1204, a connection such as connection 1206, a cache such as cache 1208, a storage device such as storage device 1210, memory such as memory 1214, an input device such as input device 1216, and an output device such as output device 1218. In such embodiments, the computing device 1224 can carry out the functions such as those described herein in connection with computing device 1202. In some embodiments, the computing device 1202 can be connected to a plurality of computing devices such as computing device 1224, each of which may also be connected to a plurality of computing devices such as computing device 1224. Such an embodiment may be referred to herein as a distributed computing environment.

The network 1222 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1222 can be wired connections, wireless connections, or combinations thereof. Communications via the network 1222 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1222, within the computing device 1202, within the computing device 1224, or within the computing resources provider 1228 can include information, which also may be referred to herein as content. The information may include text, graphics, audio, video, haptics, and/or any other information that can be provided to a user of the computing device such as the computing device 1202. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1202 and presented to a user of the computing device 1202 using forms that are perceptible via sight, sound, smell, taste, touch, or other such mechanisms. In some embodiments, communications over the network 1222 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1202 and/or the computing device 1224 can be connected to a computing resources provider 1228 via the network 1222 using a network interface such as those described herein (e.g. network interface 1220). In such embodiments, one or more systems (e.g., service 1230 and service 1232) hosted within the computing resources provider 1228 (also referred to herein as within “a computing resources provider environment”) may execute one or more services to perform one or more functions under the control of, or on behalf of, programs and/or services operating on computing device 1202 and/or computing device 1224. Systems such as service 1230 and service 1232 may include one or more computing devices such as those described herein to execute computer code to perform the one or more functions under the control of, or on behalf of, programs and/or services operating on computing device 1202 and/or computing device 1224.

For example, the computing resources provider 1228 may provide a service, operating on service 1230 to store data for the computing device 1202 when, for example, the amount of data that the computing device 1202 exceeds the capacity of storage device 1210. In another example, the computing resources provider 1228 may provide a service to first instantiate a virtual machine (VM) on service 1232, use that VM to access the data stored on service 1232, perform one or more operations on that data, and provide a result of those one or more operations to the computing device 1202. Such operations (e.g., data storage and VM instantiation) may be referred to herein as operating “in the cloud,” “within a cloud computing environment,” or “within a hosted virtual machine environment,” and the computing resources provider 1228 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1228 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1230 and service 1232 may implement versions of various services (e.g., the service 1212 or the service 1226) on behalf of, or under the control of, computing device 1202 and/or computing device 1224. Such implemented versions of various services may involve one or more virtualization techniques so that, for example, it may appear to a user of computing device 1202 that the service 1212 is executing on the computing device 1202 when the service is executing on, for example, service 1230. As may also be contemplated, the various services operating within the computing resources provider 1228 environment may be distributed among various systems within the environment as well as partially distributed onto computing device 1224 and/or computing device 1202.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1202) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1202.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving in real-time a set of messages between a member and a representative as the set of messages are being exchanged;
processing the set of messages in real-time to automatically identify a goal specific to the member and a timeframe for achieving the goal, wherein the set of messages are processed according to a member profile corresponding to the member;
querying a set of other member profiles corresponding to other members to identify one or more members associated with a set of goals similar to the identified goal;
identifying a task grouping for achieving the goal, wherein the task grouping is identified based on member profiles corresponding to the one or more members associated with the set of goals, and wherein the task grouping corresponds to a method for achieving the goal;
generating a proposal option corresponding to the task grouping;
receiving input corresponding to a selection of the proposal option, wherein the selection indicates that the task grouping is to be performed to achieve the goal;
monitoring performance of the task grouping in real-time according to the timeframe; and
updating the member profile, wherein the member profile is updated using the goal, the proposal option, the selection, and the performance of the task grouping.

2. The computer-implemented method of claim 1, wherein querying the set of other member profiles to identify the one or more members further includes:
processing the identified goal, the member profile, and the set of other member profiles through a trained machine learning algorithm to identify the one or more members.

3. The computer-implemented method of claim 1, wherein identifying the task grouping further includes:
identifying different task groupings previously completed to achieve the set of goals; and
modifying the different task groupings according to the goal and the member profile to generate the task grouping.

4. The computer-implemented method of claim 1, further comprising:
detecting that a task of the task grouping has not been completed according to the timeframe;
identifying one or more remedial actions performable to achieve the goal within the timeframe; and
propagating the one or more remedial actions to the other members for similar goals associated with the other members.

5. The computer-implemented method of claim 1, wherein querying the set of other member profiles to identify the one or more members further includes:
processing the goal and the set of messages through a trained clustering algorithm to identify a cluster that includes the set of goals.

6. The computer-implemented method of claim 1, wherein the task grouping is identified according to a ranking of different task groupings generated for achieving the goal, and wherein the task grouping is selected from the ranking according to a likelihood of the member selecting the task grouping.

7. The computer-implemented method of claim 1, further comprising:
processing the set of messages and the member profile through a trained machine learning algorithm to generate a cognitive load score associated with the member; and
determining that the goal is achievable within the timeframe based on the cognitive load score.

8. A system, comprising:
one or more processors; and
memory storing thereon instructions that, as a result of being executed by the one or more processors, cause the system to:
receive in real-time a set of messages between a member and a representative as the set of messages are being exchanged;
process the set of messages in real-time to automatically identify a goal specific to the member and a timeframe for achieving the goal, wherein the set of messages are processed according to a member profile corresponding to the member;
query a set of other member profiles corresponding to other members to identify one or more members associated with a set of goals similar to the identified goal;
identify a task grouping for achieving the goal, wherein the task grouping is identified based on member profiles corresponding to the one or more members associated with the set of goals, and wherein the task grouping corresponds to a method for achieving the goal;
generate a proposal option corresponding to the task grouping;
receive input corresponding to a selection of the proposal option, wherein the selection indicates that the task grouping is to be performed to achieve the goal;
monitoring performance of the task grouping in real-time according to the timeframe; and
update the member profile, wherein the member profile is updated using the goal, the proposal option, the selection, and the performance of the task grouping.

9. The system of claim 8, wherein the instructions that cause the system to query the set of other member profiles to identify the one or more members further cause the system to:
process the identified goal, the member profile, and the set of other member profiles through a trained machine learning algorithm to identify the one or more members.

10. The system of claim 8, wherein the instructions that cause the system to identify the task grouping further cause the system to:
identify different task groupings previously completed to achieve the set of goals; and
modify the different task groupings according to the goal and the member profile to generate the task grouping.

11. The system of claim 8, wherein the instructions further cause the system to:
detect that a task of the task grouping has not been completed according to the timeframe;
identify one or more remedial actions performable to achieve the goal within the timeframe; and
propagate the one or more remedial actions to the other members for similar goals associated with the other members.

12. The system of claim 8, wherein the instructions that cause the system to query the set of other member profiles to identify the one or more members further cause the system to:
process the goal and the set of messages through a trained clustering algorithm to identify a cluster that includes the set of goals.

13. The system of claim 8, wherein the task grouping is identified according to a ranking of different task groupings generated for achieving the goal, and wherein the task grouping is selected from the ranking according to a likelihood of the member selecting the task grouping.

14. The system of claim 8, wherein the instructions further cause the system to:
process the set of messages and the member profile through a trained machine learning algorithm to generate a cognitive load score associated with the member; and
determine that the goal is achievable within the timeframe based on the cognitive load score.

15. A non-transitory, computer-readable storage medium storing thereon executable instructions that, as a result of being executed by a computer system, cause the computer system to:
receive in real-time a set of messages between a member and a representative as the set of messages are being exchanged;
process the set of messages in real-time to automatically identify a goal specific to the member and a timeframe for achieving the goal, wherein the set of messages are processed according to a member profile corresponding to the member;
query a set of other member profiles corresponding to other members to identify one or more members associated with a set of goals similar to the identified goal;
identify a task grouping for achieving the goal, wherein the task grouping is identified based on member profiles corresponding to the one or more members associated with the set of goals, and wherein the task grouping corresponds to a method for achieving the goal;
generate a proposal option corresponding to the task grouping;
receive input corresponding to a selection of the proposal option, wherein the selection indicates that the task grouping is to be performed to achieve the goal;
monitoring performance of the task grouping in real-time according to the timeframe; and
update the member profile, wherein the member profile is updated using the goal, the proposal option, the selection, and the performance of the task grouping.

16. The non-transitory, computer-readable storage medium of claim 15, wherein the executable instructions that cause the computer system to query the set of other member profiles to identify the one or more members further cause the computer system to:
process the identified goal, the member profile, and the set of other member profiles through a trained machine learning algorithm to identify the one or more members.

17. The non-transitory, computer-readable storage medium of claim 15, wherein the executable instructions that cause the computer system to identify the task grouping further cause the computer system to:
identify different task groupings previously completed to achieve the set of goals; and
modify the different task groupings according to the goal and the member profile to generate the task grouping.

18. The non-transitory, computer-readable storage medium of claim 15, wherein the executable instructions further cause the computer system to:
detect that a task of the task grouping has not been completed according to the timeframe;
identify one or more remedial actions performable to achieve the goal within the timeframe; and
propagate the one or more remedial actions to the other members for similar goals associated with the other members.

19. The non-transitory, computer-readable storage medium of claim 15, wherein the executable instructions that cause the computer system to query the set of other member profiles to identify the one or more members further cause the computer system to:
process the goal and the set of messages through a trained clustering algorithm to identify a cluster that includes the set of goals.

20. The non-transitory, computer-readable storage medium of claim 15, wherein the task grouping is identified according to a ranking of different task groupings generated for achieving the goal, and wherein the task grouping is selected from the ranking according to a likelihood of the member selecting the task grouping.

21. The non-transitory, computer-readable storage medium of claim 15, wherein the executable instructions further cause the computer system to:
process the set of messages and the member profile through a trained machine learning algorithm to generate a cognitive load score associated with the member; and
determine that the goal is achievable within the timeframe based on the cognitive load score.
